(19) United States
(12) Patent Application Publication
(10) Pub. No.: US 2026/0341296 A1
(43) Pub. Date: Oct. 29, 2026

(54) METHOD AND APPARATUS FOR CAPTURING AUDIO

(71) Applicant: KONINKLIJKE PHILIPS N.V., EINDHOVEN (NL)

(72) Inventors: Cornelis Pieter Janse, Eindhoven (NL); Brian Brand Antonius Johannes Bloemendal, Eindhoven (NL); Rik Jozef Martnus Janssen, Eindhoven (NL)

(21) Appl. No.: 19/485,379

(22) PCT Filed: May 20, 2024
(86) PCT No.: PCT/EP2024/063839

§ 371 Date: Nov. 18, 2025

(30) Foreign Application Priority Data
May 30, 2023 (EP) 23176012.5

(51) Int. Cl. G10L 21/0272; G10L 21/0216; G10L 25/84

(52) U.S. Cl. CPC G10L 21/0272; G10L 21/0216; G10L 25/84; G10L 2021/02166

(57) ABSTRACT

An apparatus for capturing audio comprises a first beamformer (305) is coupled to a microphone array (301) via an adaptive spatial decorrelator (303). A plurality of constrained beamformers (309, 311) each generates a beamformed audio signal. A first adapter (307) adapts beamform parameters of the first beamformer (305) and a second adapter (313) adapts constrained beamform parameters for the plurality of constrained beamformers (309, 311). A difference processor (317) determines a difference measure for the constrained beamformers (309, 311) where the difference measure is indicative of the difference between beams formed by the first beamformer (305) and the constrained beamformers (309, 311). The second adapter (313) adapts constrained beamform parameters with the constraint that beamform parameters are adapted only for constrained beamformers of the plurality of constrained beamformers (309, 311) for which a difference measure has been determined that meets a similarity criterion. A third adapter (319) adapts the adaptive spatial decorrelator (303) based on the input signals to the adaptive spatial decorrelator (303).

### FIELD OF THE INVENTION

The invention relates to audio capture using beamforming and in particular, but not exclusively, to speech capture using beamforming.

### BACKGROUND OF THE INVENTION

Capturing audio, and in particularly speech, has become increasingly important in the last decades. For example, capturing speech or other audio has become increasingly important for a variety of applications including telecommunication, teleconferencing, gaming, audio user interfaces, etc. However, a problem in many scenarios and applications is that the desired audio source is typically not the only audio source in the environment. Rather, in typical audio environments there are many other audio/noise sources which are being captured by the microphone. Audio processing is often used to improve the capture of audio, and in particular to post-process the captured audio to improve the resulting audio signals.

In many practical applications, audio is captured by a plurality of microphones at different positions. For example, a linear array of a plurality of microphones is often used to capture audio in an environment, such as in a room. The use of multiple microphones allows spatial information of the audio to be captured and applications have been developed that exploit such spatial information allowing improved and/or new services.

One frequently used approach is to try to separate audio sources by applying audio beamforming to form beams in the direction of arrival of audio from specific audio sources. However, although this may provide advantageous performance in many scenarios, it is not optimal in all cases. For example, it may not provide optimal source separation in some cases, and indeed in some applications such a spatial beamforming may not provide audio properties that are ideal for further processing to achieve a given effect.

Thus, whereas spatial audio source separation, and specifically such separation based on audio beamforming, is highly advantageous in many scenarios and applications, there is a desire to improve the performance and operation of such approaches. However, there is typically also a desire for low complexity and/or resource usage (e.g. computational resource usage) and often these preferences conflict with each other.

Further, there is in many applications a strong desire for the audio capture to be able to adapt to the specific audio scene and sources, including for example adapting to changes in who is currently speaker or in changes of the positions of the current speaker(s). It is also desired that speech capture is resilient to other audio and noise being present in the scene. For example, it is often desirable for a capture system to be able to capture a desired speaker even in the presence of another strong audio source.

Hence, an improved approach would be advantageous, and in particular an approach allowing reduced complexity, increased flexibility, facilitated implementation, reduced cost, improved audio capture, improved spatial perception/differentiation of audio sources, improved audio source separation, improved audio/speech application support, reduced dependency on known or static acoustic properties, improved flexibility and customization to different audio environments and scenarios, improved audio beamforming, improved resilience to noise and unwanted audio sources in the audio scene, an improved trade-off between performance and complexity/resource usage, and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an apparatus for capturing audio, the apparatus comprising: a receiver arranged to receive a first set of audio signals; an adaptive spatial decorrelator arranged to apply spatial decorrelation filtering to the first set of audio signals to generate a second set of audio signals; a first beamformer coupled to the adaptive spatial decorrelation filter and arranged to generate a first beamformed audio output signal from the second set of audio signals; a plurality of constrained beamformers coupled to the adaptive spatial decorrelator and each arranged to generate a constrained beamformed audio output signal from the second set of audio signals, each constrained beamformer having constrained beamform parameters and the constrained beamform parameters of the plurality of constrained beamformers (309, 311) forming a set of beamform parameters; an output processor arranged to generate an output audio signal from the constrained beamformed audio output signals; a first adapter arranged to adapt beamform parameters of the first beamformer; a difference processor arranged to determine a difference measure for each of the plurality of constrained beamformers, the difference measure for the each of the plurality of constrained beamformers being indicative of a difference between a beam formed by the first beamformer and a beam formed by the each of the plurality of constrained beamformers; a second adapter arranged to adapt constrained beamform parameters of the set of constrained beamform parameters for the plurality of constrained beamformers with a constraint that constrained beamform parameters of the set of constrained beamform parameters are adapted only for constrained beamformers of the plurality of constrained beamformers for which a difference measure has been determined that meets a similarity criterion; and a third adapter arranged to adapt coefficients of the spatial decorrelation filtering in response to update values determined from the first set of audio signals, the update values being determined to reduce correlation of the second set of audio signals.

The invention may provide improved audio capture in many embodiments. In particular, improved performance in reverberant environments and/or for audio sources may often be achieved. The approach may in particular provide improved speech capture in many challenging audio environments. In many embodiments, the approach may provide reliable and accurate beam forming while at the same time providing fast adaptation to new desired audio sources. The approach may provide an audio capturing apparatus having reduced sensitivity to e.g. noise, reverberation, and reflections. In particular, improved capture of audio sources outside the reverberation radius can often be achieved.

The approach may typically provide improved capture of desired audio in the presence of noise, and potentially in the presence of a strong interferer/noise source. The approach may in many scenarios provide improved extraction/separation/isolation of desired audio and/or may reduce the impact of a strong undesired audio source. The synergistic effect between the adaptive spatial decorrelation and beamforming may allow an improved attenuation of a noise audio source and allow improved extraction of desired audio sources, such as specifically speech sources.

In some embodiments, an output audio signal from the audio capturing apparatus may be generated in response to the first beamformed audio output and/or the constrained beamformed audio output. In some embodiments, the output audio signal may be generated as a combination of the constrained beamformed audio output, and specifically a selection combining selecting e.g. a single constrained beamformed audio output may be used.

The difference measure may reflect the difference between the formed beams of the first beamformer and of the constrained beamformer for which the difference measure is generated, e.g. measured as a difference between directions of the beams. In many embodiments, the difference measure may be indicative of a difference between the beamformed audio outputs from the first beamformer and the constrained beamformer. In some embodiments, the difference measure may be indicative of a difference between the beamform filters of the first beamformer and of the constrained beamformer. The difference measure may be a distance measure, such as e.g. a measure determined as the distance between vectors of the coefficients of the beamform filters of the first beamformer and the constrained beamformer.

It will be appreciated that a similarity measure may be equivalent to a difference measure in that a similarity measure by providing information relating to the similarity between two features inherently also provides information relating the difference between these, and vice versa.

The similarity criterion may for example comprise a requirement that the difference measure is indicative of a difference being below a given measure, e.g. it may be required that a difference measure having increasing values for increasing difference is below a threshold.

The constrained beamformers are constrained in that the adaptation is subject to the constraint that adaptation is only performed if the difference measure meets the similarity criterion. In contrast, the first beamformer is not subject to this requirement. In particular, the adaptation of the first beamformer may be independent of any of the constrained beamformers and specifically may be independent of the beamforming of these beams.

The restriction of the adaptation to require that the difference measure is e.g. below a threshold can be considered to correspond to adaptation only being for constrained beamformers that currently form beams corresponding to audio sources in a region close to an audio source to which the first beamformer is currently adapted.

Adaptation of the beamformers may be by adapting filter parameters of the beamform filters of the beamformers, such as specifically by adapting filter coefficients. The adaptation may seek to optimize (maximize or minimize) a given adaptation parameter, such as e.g. maximizing an output signal level when an audio source is detected or minimizing it when only noise is detected. The adaptation may seek to modify the beamform filters to optimize a measured parameter.

The spatial decorrelation filtering may be a frequency domain filtering wherein for each output signal an output value for a given frequency bin is determined as a weighted combination of values of the set of input signals for that frequency bin.

In many embodiments, the output processor may further be arranged to generate the output audio signal from the first beamformed audio output signal.

The second adapter may be arranged to adapt constrained beamform parameters (of the set of constrained beamform parameters) for the plurality of constrained beamformers with a constraint that only constrained beamform parameters (of the set of constrained beamform parameters) for constrained beamformers of the plurality of constrained beamformers for which a difference measure has been determined that meets a similarity criterion are adapted.

The set of beamform parameters may be (formed by/comprise) the (combined/total/accumulated) constrained beamform parameters for each constrained beamformer of the plurality of constrained beamformers. The set of beamform parameters may include all the constrained beamform parameters for the plurality of the constrained beamformers.

In accordance with an optional feature of the invention, the third adapter is arranged to designate at least a first constrained beamformed audio output signal of a first constrained beamformer of the plurality of constrained beamformers as a speech audio signal or as a noise audio signal; and the third adapter is arranged to update coefficients of the spatial decorrelation filtering in response to a difference measure for the first constrained beamformer (only) if the first constrained beamformed audio output signal is designated as a noise audio signal.

This may provide improved performance and/or operation in many embodiments. It may typically provide improved adaptation of the adaptive spatial decorrelator 303 to specifically decorrelate noise sources of the scene in the captured audio. It may typically allow improved separation and extraction of desired audio (e.g. speech audio sources) in the presence of strong interference/noise.

The third adapter may specifically be arranged to designate at least a first constrained beamformed audio output signal of a first constrained beamformer as a speech audio signal or a non-speech audio signal. The third adapter may be arranged to designate the first constrained beamformed audio output signal in response to properties of the first constrained beamformed audio output signal. The third adapter may be arranged to designate the first constrained beamformed audio output signal as a noise audio signal in response to a speech detection applied to the first constrained beamformed audio output signal failing to detect speech.

In accordance with an optional feature of the invention, the output processor is arranged to generate the output audio signal to not include a contribution from the first constrained beamformed audio output signal if the first constrained beamformed audio output signal is designated as a noise audio signal.

This may provide improved performance and/or operation in many embodiments. It may typically provide an improved user experience.

In accordance with an optional feature of the invention, the third adapter is arranged to initialize a given constrained beamformer of the plurality of constrained beamformers with beamform parameters matching beamform parameters of the first beamformer in response to a detection that no beamformer of the plurality of constrained beamformers has a difference measure meeting a similarity criterion.

This may provide improved performance and/or operation in many embodiments. It may typically provide an improved user experience.

In accordance with an optional feature of the invention, the initializing a given constrained beamformer comprises initially designating a given constrained beamformed audio output signal of the given constrained beamformer as a speech audio signal.

This may provide improved performance and/or operation in many embodiments. It may typically provide an improved user experience.

In accordance with an optional feature of the invention, the third adapter is arranged to apply a speech detection to the given constrained beamformed audio output signal and to re-designate the given constrained beamformed audio output signal from a speech audio signal to a noise audio signal in response to a detection that the given constrained beamformed audio output signal does not comprise a speech signal component having a level above a threshold.

This may provide improved performance and/or operation in many embodiments. It May typically provide an improved user experience.

In accordance with an optional feature of the invention, the third adapter is arranged to initialize the given constrained beamformer only if a level of the first beamformed audio output signal exceeds a level of the constrained beamformed audio output signal from all constrained beamformers.

This may provide improved performance and/or operation in many embodiments. It may typically provide an improved user experience.

In accordance with an optional feature of the invention, the second adapter is arranged to only adapt the constrained beamform parameters of the set of constrained beamform parameters for a given constrained beamformer if a criterion is met comprising at least one requirement selected from the group of: a requirement that a level of a constrained beamformed audio output signal of the given constrained beamformer is higher than for any other constrained beamformer; a requirement that a level of a constrained beamformed audio output signal of the given constrained beamformer exceeds a given threshold; a requirement that a level of a point audio source in the constrained beamformed audio output signal of the given constrained beamformer is higher than for any point audio source in any other constrained beamformed audio output signal; and a requirement that a signal to noise ratio for the constrained beamformed audio output signal of the given constrained beamformer exceeds a threshold.

In accordance with an optional feature of the invention, a maximum number of constrained beamformers being simultaneously updated is one.

In accordance with an optional feature of the invention, the adaptive spatial decorrelator is arranged to link each audio signal of the second set of audio signals with one audio signal of the first set of audio signals, and to generate the second set of audio signals, by performing the steps of: segmenting the first set of audio signals into time segments, and for at least some time segments performing the steps of: generating a frequency bin representation of the first set of audio signals, each frequency bin of the frequency bin representation of the first set of audio signals comprising a frequency bin value for each of the audio signals of the first set of audio signals; generating a frequency bin representation of the second set of audio signals, each frequency bin of the frequency bin representation of the second set of audio signals comprising a frequency bin value for each of the second set of audio signals, the frequency bin value for a given audio signal of the second set of output audio signals for a given frequency bin being generated as a weighted combination of frequency bin values of the first set of audio signals for the given frequency bin; updating a first weight for a contribution to a first frequency bin value of a first frequency bin for a first output signal linked with a first input audio signal from a second frequency bin value of the first frequency bin for a second input audio signal linked to a second output signal in response to a correlation measure between a first previous frequency bin value of the first output signal for the first frequency bin and a second previous frequency bin value of the second output signal for the first frequency bin; and the third adapter is arranged to update weights of the weighted combination including updating a first weight for a contribution to a first frequency bin value of a first frequency bin for a first output audio signal of the second set of audio signals linked with a first audio signal of the first set of audio signals from a second frequency bin value of the first frequency bin for a second audio signal of the first set of audio signals being linked to a second output audio signal of the second set of audio signals in response to a correlation measure between a first previous frequency bin value of the first output audio signal for the first frequency bin and a second previous frequency bin value of the second output audio signal for the first frequency bin.

This may provide improved performance and/or operation in many embodiments. In many embodiments and scenarios, this may provide particularly attractive performance and/or implementation.

This may provide an advantageous generation of a second set of audio signals with typically increased decorrelation/decoherence in comparison to the input signals. The approach may provide an efficient adaptation of the operation resulting in improved decorrelation in many embodiments. The adaptation may typically be implemented with low complexity and/or resource usage. The approach may specifically apply a local adaptation of individual weights yet achieve an efficient global adaptation.

In accordance with an optional feature of the invention, the adaptive coefficient processor is arranged to update the first weight in response to a product of a first value and a second value, the first value being one of the first previous frequency bin value and the second previous frequency bin value and the second value being a complex conjugate of the other of the first previous frequency bin value and the second previous frequency bin value.

In accordance with an optional feature of the invention, the adapter is arranged to determine output bin values for the given frequency bin w from:

y(ω)=W(ω)x(ω)
where y(ω) is a vector comprising the frequency bin values for the output audio signals for the given frequency bin ω; x(ω) is a vector comprising the frequency bin values for the input audio signals for the given frequency bin ω; and W(ω) is a matrix having rows comprising weights of a weighted combination for the output audio signals.

This may provide improved performance and/or operation in many embodiments. It may typically provide improved adaptation leading to increased decorrelation/decoherence of the second set of audio signals in many scenarios.

In accordance with an optional feature of the invention, the adapter is arranged to adapt weights wᵢⱼ of the matrix W(ω) according to:

wᵢⱼ(k+1,ω)=wᵢⱼ(k,ω)−η(k,ω)[yᵢ(k,ω)yⱼ*(k,ω)]
where i is a row index of the matrix W(ω), j is a column index of the matrix W(ω), k is a time segment index, w represents the frequency bin, and η(k, ω) is a scaling parameter for adapting an adaptation speed.

This may provide improved performance and/or operation in many embodiments. It may typically provide improved adaptation leading to increased decorrelation of the second set of audio signals in many scenarios.

According to an aspect of the invention there is provided a method of capturing audio, the method comprising: receiving a first set of audio signals; applying a spatial decorrelation filtering to the first set of audio signals to generate a second set of audio signals; a first beamformer generating a first beamformed audio output signal from the second set of audio signals; a plurality of constrained beamformers each generating a constrained beamformed audio output signal from the second set of audio signals, each constrained beamformer having constrained beamform parameters; generating an output audio signal from the constrained beamformed audio output signals; adapting beamform parameters of the first beamformer; determining a difference measure for each of the plurality of constrained beamformers, the difference measure being indicative of a difference between a beam formed by the first beamformer and a beam formed by the each of the plurality of constrained beamformers; adapting constrained beamform parameters of the set of constrained beamform parameters for the plurality of constrained beamformers with a constraint that constrained beamform parameters of the set of constrained beamform parameters are adapted only for constrained beamformers of the plurality of constrained beamformers for which a difference measure has been determined that meets a similarity criterion; and adapting coefficients of the spatial decorrelation filtering in response to update values determined from the first set of audio signals, the update values being determined to reduce correlation of the second set of audio signals.

In some embodiments, the audio apparatus may be arranged to update a second weight being for a contribution to the first frequency bin value from a third frequency bin value being a frequency bin value of the first frequency bin for the first input audio signal in response to a magnitude of the first previous frequency bin value.

This may provide improved performance and/or operation in many embodiments. It may typically provide improved adaptation leading to increased decorrelation of the output audio signals in many scenarios. It may in particular provide an improved adaptation of the generated output signals. In many embodiments, the updating of the weight reflecting the contribution to an output signal from the linked input signal may be dependent on the signal magnitude/amplitude of that linked input signal. For example, the updating may seek to compensate the weight for the level of the input signal to generate a normalized output signal.

The approach may allow a normalization/signal compensation/level compensation to provide e.g., a desired output level.

In some embodiments, the audio apparatus may be arranged to set a weight for a contribution to the first frequency bin value from a third frequency bin value being a frequency bin value of the first frequency bin for the first input audio signal to a predetermined value.

This may provide improved performance and/or operation in many embodiments. It may typically provide improved adaptation leading to increased decorrelation of the output audio signals in many scenarios. It may in many embodiments provide improved adaptation while ensuring convergence of the adaptation towards a non-zero signal level. It may interwork very efficiently with the adaptation of weights that are not for linked signal pairs.

In many embodiments, the adapter may be arranged to keep the weight constant and with no adaptation or updating of the weight.

In some embodiments, the audio apparatus may be arranged to constrain a weight for a contribution to the first frequency bin value from a third frequency bin value being a frequency bin value of the first frequency bin for the first input audio signal to be a real value.

This may provide improved performance and/or operation in many embodiments. It may typically provide improved adaptation leading to increased decorrelation of the output audio signals in many scenarios.

The weights between linked input/output signals may advantageously be determined as/constrained to be a real valued weight. This may lead to improved performance and adaptation ensuring convergence on a non-zero level solution.

In some embodiments, the audio apparatus may be arranged to set a second weight being a weight for a contribution to a fourth frequency bin value of the first frequency bin for the second output audio signal from the first input audio signal to be a complex conjugate of the first weight.

This may provide improved performance and/or operation in many embodiments. It may typically provide improved adaptation leading to increased decorrelation of the output audio signals in many scenarios.

The two weights for two pairs of input/output signals may be complex conjugates of each other in many embodiments.

In some embodiments, weights of the weighted combination for other input audio signals than the first input audio signal are complex valued weights.

This may provide improved performance and/or operation in many embodiments. The use of complex values for weights for non-linked input signals provide an improved frequency domain operation.

The matrix W(ω) may advantageously be Hermitian. In many embodiments, the diagonal of the matrix W(ω) may be constrained to be real values, may be set to a predetermined value(s), and/or may not be updated/adapted but may be maintained as a fixed value. The weights/coefficients outside the diagonal may generally be complex values.

In some embodiments, the audio apparatus may be arranged to compensate the correlation value for a signal level of the first frequency bin.

This may provide improved performance and/or operation in many embodiments. It may typically provide improved adaptation leading to increased decorrelation of the output audio signals in many scenarios. It may allow a compensation of the update rate for signal variations.

In some embodiments, the audio apparatus may be arranged to initialize the weights for the weighted combination to comprise at least one zero value weight and one non-zero value weight.

This may provide improved performance and/or operation in many embodiments. It may typically provide improved adaptation leading to increased decorrelation of the output audio signals in many scenarios. It may allow a more efficient and/or quicker adaptation and convergence towards advantageous decorrelation. In many embodiments, the matrix W(ω) may be initialized with zero values for weights or coefficients for nonlinked signals and fixed non-zero real values for linked signals. Typically, the weights may be set to e.g., 1 for weights on the diagonal and all other weights may initially be set to zero.

In some embodiments, the weighted combination comprises applying a time domain windowing to a frequency representation of weights formed by weights for the first input audio signal and the second input audio signal for different frequency bins.

This may provide improved performance and/or operation in many embodiments. It may typically provide improved adaptation leading to increased decorrelation of the output audio signals in many scenarios.

Applying the time domain windowing to the frequency representation of weights may comprise: converting the frequency representation of weights to a time domain representation of weights; applying a window to the time domain representation to generate a modified time domain representation; and converting the modified time domain representation to the frequency domain.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of elements of a beamforming audio capturing system;

FIG. 2 illustrates an example of a plurality of beams formed by an audio capturing system; and

FIG. 3 illustrates an example of elements of an audio capturing apparatus in accordance with some embodiments of the invention; and

FIG. 4 illustrates some elements of a possible arrangement of a processor for implementing elements of an audio apparatus in accordance with some embodiments of the invention.

### DETAILED DESCRIPTION OF SOME EMBODIMENTS OF THE INVENTION

The following description focuses on embodiments of the invention applicable to a speech capturing audio system based on beamforming, and in particular to extraction of one or more desired speech sources from an audio scene.

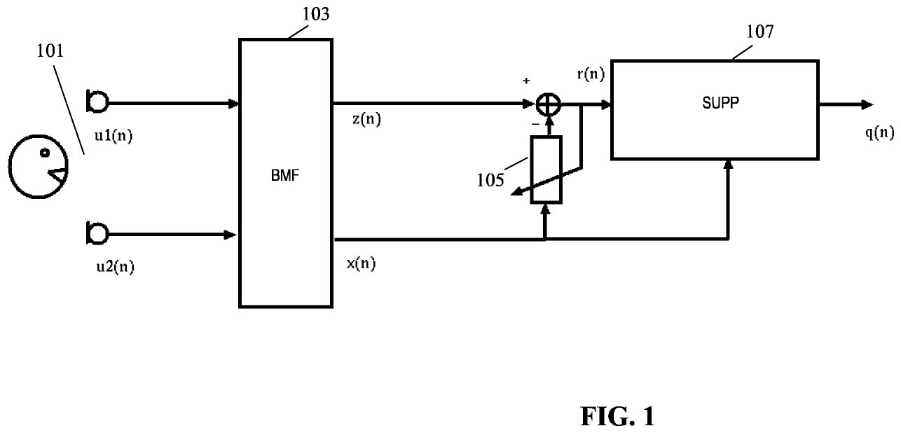

Conventionally, capturing of speech and audio in an audio scene often includes echo cancellation and noise suppression and more recently beamforming. An example of an audio capture system based on beamforming is illustrated in FIG. 1. In the example, an array of a plurality of microphones 101 are coupled to a beamformer 103 which generates an audio source signal z(n) and one or more noise reference signal(s) x(n).

The microphone array 101 may in some embodiments comprise only two microphones but will typically comprise a higher number.

The beamformer 103 may specifically be an adaptive beamformer in which one beam can be directed towards the speech source using a suitable adaptation algorithm.

For example, U.S. Pat. Nos. 7,146,012 and 7,602,926 discloses examples of adaptive beamformers that focus on the speech but also provides a reference signal that often contains (almost) no speech.

The beamformer creates an enhanced output signal, z(n), by adding the desired part of the microphone signals coherently by filtering the received signals in forward matching filters and adding the filtered outputs. Also, the output signal is filtered in backward adaptive filters having conjugate filter responses to the forward filters (in the frequency domain corresponding to time inversed impulse responses in the time domain). Error signals are generated as the difference between the input signals and the outputs of the backward adaptive filters, and the coefficients of the filters are adapted to minimize the error signals thereby resulting in the audio beam being steered towards the dominant signal. The generated error signals x(n) can be considered as noise reference signals which are particularly suitable for performing additional noise reduction on the enhanced output signal z(n).

The primary signal z(n) and the reference signal x(n) are typically both contaminated by noise. In case the noise in the two signals is coherent (for example when there is an interfering point noise source), an adaptive filter 105 can be used to reduce the coherent noise.

For this purpose, the noise reference signal x(n) is coupled to the input of the adaptive filter 105 with the output being subtracted from the audio source signal z(n) to generate a compensated signal r(n). The adaptive filter 105 is adapted to minimize the power of the compensated signal r(n), typically when the desired audio source is not active (e.g. when there is no speech) and this results in the suppression of coherent noise.

The compensated signal is fed to a post-processor 107 which performs noise reduction on the compensated signal r(n) based on the noise reference signal x(n). Specifically, the post-processor 107 transforms the compensated signal r(n) and the noise reference signal x(n) to the frequency domain using a short-time Fourier transform. It then, for each frequency bin, modifies the amplitude of R(ω) by subtracting a scaled version of the amplitude spectrum of X(ω). The resulting complex spectrum is transformed back to the time domain to yield the output signal q (n) in which noise has been suppressed. This technique of spectral subtraction was first described in S. F. Boll, “Suppression of Acoustic Noise in Speech using Spectral Subtraction,” IEEE Trans. Acoustics, Speech and Signal Processing, vol. 27, pp. 113-120, April 1979.

Although the system of FIG. 1 provides very efficient operation and advantageous performance in many scenarios, it is by itself not optimum in all scenarios. Indeed, whereas many conventional systems, including the example of FIG. 1, provide very good performance when the desired audio source/speaker is within the reverberation radius of the microphone array, i.e. for applications where the direct energy of the desired audio source is (preferably significantly) stronger than the energy of the reflections of the desired audio source, it tends to provide less optimum results when this is not the case. In typical environments, it has been found that a speaker typically should be within 1-1.5 meter of the microphone array.

However, there is a strong desire for audio based hands-free solutions, applications, and systems where the user may be at further distances from the microphone array. This is for example desired both for many communication applications and for many voice control systems and applications.

In more detail, when dealing with additional diffuse noise and a desired speaker outside the reverberation radius the following problems may occur:
The beamformer may often have problems distinguishing between echoes of the desired speech and diffuse background noise, resulting in speech distortion.
The adaptive beamformer may converge slower towards the desired speaker. During the time when the adaptive beam has not yet converged, there will be speech leakage in the reference signal, resulting in speech distortion in case this reference signal is used for non-stationary noise suppression and cancellation. The problem increases when there are more desired sources that talk after each other.

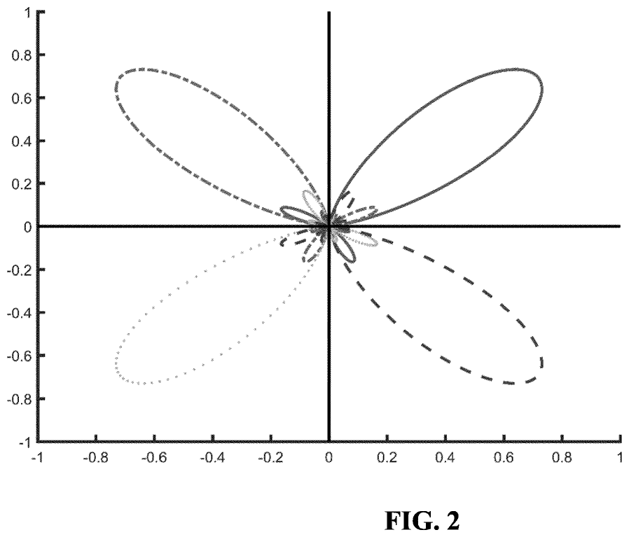

A solution to deal with slower converging adaptive filters (due to the background noise) is to supplement this with a number of fixed beams being aimed in different directions as illustrated in FIG. 2. However, this approach is particularly developed for scenarios wherein a desired audio source is present within the reverberation radius. It may be less efficient for audio sources outside the reverberation radius and may often lead to non-robust solutions in such cases, especially if there is also acoustic diffuse background noise.

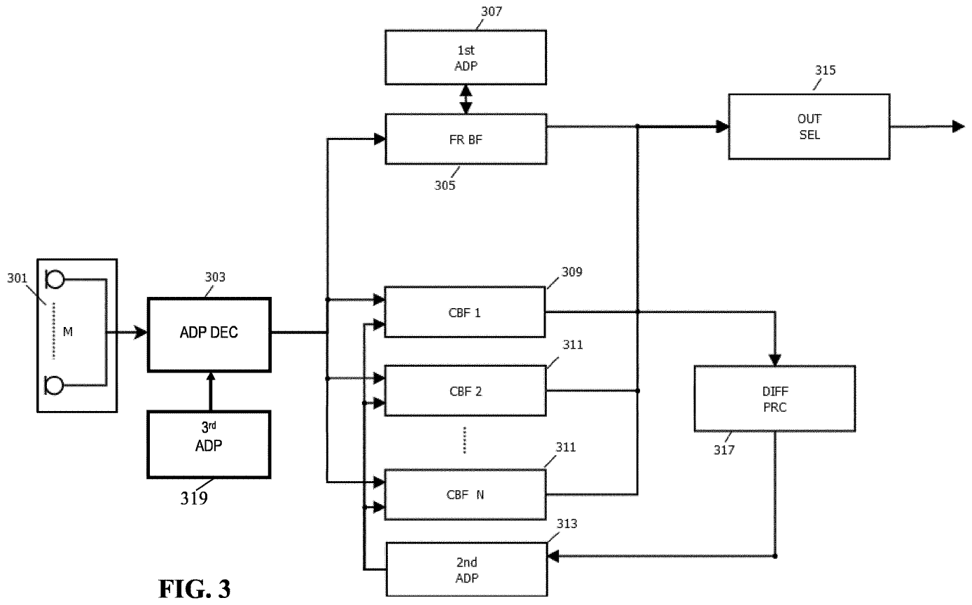

FIG. 3 illustrates an example of elements of an audio apparatus in accordance with some embodiments of the invention. The audio apparatus may in many scenarios address or mitigate a number of the disadvantages of conventional systems, such as specifically a number of the issues of using a single beamformer such as that of FIG. 1.

The audio apparatus comprises a receiver 301 which is arranged to receive a first set of audio signals. The receiver 301 is specifically arranged to receive audio signals from a microphone array 301 which comprises a plurality of microphones arranged to capture audio in the environment from different respective positions. In the example, the receiver 301 receives audio signals from a set of microphones capturing the audio scene from different positions. The microphones may for example be arranged in a linear array and relatively close to each other. For example, the maximum distance between capture points for the audio signals may in many embodiments not exceed 1 meter, 50 cm, 25 cm, or even in some cases 10 cm.

In some cases, the receiver may comprise an optional echo canceller which may cancel the echoes that originate from acoustic sources (for which a reference signal is available) that are linearly related to the echoes in the microphone signal(s). This source can for example be a loudspeaker. An adaptive filter can be applied with the reference signal as input, and with the output being subtracted from the microphone signal to create an echo compensated signal. This can be repeated for each individual microphone.

It will be appreciated that such an echo canceller is optional and may be omitted in many embodiments.

The receiver 301 is coupled to an adaptive spatial decorrelator 303 which is arranged to apply spatial filtering to the first set of audio signals to generate a second set of audio signals. The adaptive spatial decorrelator 303 comprises a set of filters with each filter generating one audio signal of the second set of audio signals based on multiple (and typically all) of the audio signals of the first set of audio signals. Each audio signal of the second set of audio signals (also referred to as (decorrelator) output signals) may be generated as a weighted combination of the audio signals of the first set of audio signals (also referred to as (decorrelator) input signals). The second set of audio signals are generated to correspond to the first set of audio signals (e.g. having the same overall audio energy/power) but seeks to decorrelate at least one audio source in the audio scene captured by the microphones. This is achieved by adapting the filters, and specifically the weights of the weighted summations of the decorrelation filters as will be described in more detail later.

The output of the adaptive spatial decorrelator 303 may thus correspond to the input audio but with an increased decorrelation of at least one audio source. Specifically, as will be described later, the adaptive spatial decorrelator 303 may be adapted to seek to decorrelate a dominant noise source.

The output of the adaptive spatial decorrelator 303 is then fed to a number of different beamformers.

The adaptive spatial decorrelator 303 is specifically coupled to a first beamformer 305.

The first beamformer 305 is arranged to combine the signals from the adaptive spatial decorrelator 303 such that an effective directional audio sensitivity is generated. The first beamformer 305 thus generates an output signal, referred to as the first beamformed audio output, which corresponds to a selective capturing of audio in the environment. The first beamformer 305 is an adaptive beamformer and the directivity can be controlled by setting parameters, referred to as first beamform parameters, of the beamform operation of the first beamformer 305.

The first beamformer 305 is coupled to a first adapter 307 which is arranged to adapt the first beamform parameters. Thus, the first adapter 307 is arranged to adapt the parameters of the first beamformer 305 such that the beam can be steered. The first beamformer 305 will also for brevity and clarity be referred to as an unconstrained or free-running beamformer and the audio signal generated by the first beamformer 305 will also for brevity and clarity be referred to as an unconstrained or free-running beamform signal.

The audio capturing apparatus comprises a plurality of constrained beamformers 309, 311 each of which is arranged to combine the signals from the adaptive spatial decorrelator 303 such that an effective directional audio sensitivity of the microphone array 301 is generated. Each of the constrained beamformers 309, 311 is thus arranged to generate an audio output, referred to as the constrained beamformed audio output, which corresponds to a selective capturing of audio in the environment. Similarly, to the first beamformer 305, the constrained beamformers 309, 311 are adaptive beamformers where the directivity of each constrained beamformer 309, 311 can be controlled by setting parameters, referred to as constrained beamform parameters, of the constrained beamformers 309, 311.

The audio capturing apparatus accordingly comprises a second adapter 313 which is arranged to adapt the constrained beamform parameters of the plurality of constrained beamformers thereby adapting the beams formed by these.

Both the first beamformer 305 and the constrained beamformers 309, 311 are accordingly adaptive beamformers for which the actual beam formed can be dynamically adapted. Specifically, the beamformers 305, 309, 311 are filter-and-combine (or specifically in most embodiments filter-and-sum) beamformers. A beamform filter may be applied to each of the microphone signals and the filtered outputs may be combined, typically by simply being added together.

In most embodiments, each of the beamform filters has a time domain impulse response which is not a simple Dirac pulse (corresponding to a simple delay and thus a gain and phase offset in the frequency domain) but rather has an impulse response which typically extends over a time interval of no less than 2, 5, 10 or even 30 msec.

The impulse response may often be implemented by the beamform filters being FIR (Finite Impulse Response) filters with a plurality of coefficients. The first and second adapters 307, 313 may in such embodiments adapt the beamforming by adapting the filter coefficients. In many embodiments, the FIR filters may have coefficients corresponding to fixed time offsets (typically sample time offsets) with the adapters 307, 313 being arranged to adapt the coefficient values. In other embodiments, the beamform filters may typically have substantially fewer coefficients (e.g. only two or three) but with the timing of these (also) being adaptable.

A particular advantage of the beamform filters having extended impulse responses rather than being a simple variable delay (or simple frequency domain gain/phase adjustment) is that it allows the beamformers 305, 309, 311 to not only adapt to the strongest, typically direct, signal component. Rather, it allows the beamformers 305, 309, 311 to be adapted to include further signal paths corresponding typically to reflections. Accordingly, the approach allows for improved performance in most real environments, and specifically allows improved performance in reflecting and/or reverberating environments and/or for audio sources further from the microphone array 301.

It will be appreciated that different adaptation algorithms may be used in different embodiments and that various optimization parameters will be known to the skilled person. For example, the adapters 307, 313 may adapt the beamform parameters to maximize the output signal value of the beamformer. As a specific example, consider a beamformer where the received microphone signals are filtered with forward matching filters and where the filtered outputs are added. The output signal is filtered by backward adaptive filters, having conjugate filter responses to the forward filters (in the frequency domain corresponding to time inversed impulse responses in the time domain. Error signals are generated as the difference between the input signals and the outputs of the backward adaptive filters, and the coefficients of the filters are adapted to minimize the error signals thereby resulting in the maximum output power. Further details of such an approach can be found in U.S. Pat. Nos. 7,146,012 and 7,602,926.

It is noted that approaches such as that of U.S. Pat. Nos. 7,146,012 and 7,602,926 are based on the adaptation being based both on the audio source signal z(n) and the noise reference signal(s) x(n) from the beamformers, and it will be appreciated that the same approach may be used for the system of FIG. 3.

The first beamformer 305 and the constrained beamformers 309, 311 may specifically be beamformers corresponding to the one illustrated in FIG. 1 and disclosed in U.S. Pat. Nos. 7,146,012 and 7,602,926.

In many embodiments, the structure and implementation of the first beamformer 305 and the constrained beamformers 309, 311 may be the same, e.g. the beamform filters may have identical FIR filter structures with the same number of coefficients etc.

However, the operation and parameters of the first beamformer 305 and the constrained beamformers 309, 311 will be different, and in particular the constrained beamformers 309, 311 are constrained in ways the first beamformer 305 is not. Specifically, the adaptation of the constrained beamformers 309, 311 will be different than the adaptation of the first beamformer 305 and will specifically be subject to some constraints.

Specifically, the constrained beamformers 309, 311 are subject to the constraint that the adaptation (updating of beamform filter parameters) is constrained to situations when a criterion is met whereas the first beamformer 305 will be allowed to adapt even when such a criterion is not met. Indeed, in many embodiments, the first adapter 307 may be allowed to always adapt the beamform filter with this not being constrained by any properties of the audio captured by the first beamformer 305 (or of any of the constrained beamformers 309, 311).

The criterion for adapting the constrained beamformers 309, 311 will be described in more detail later.

In many embodiments, the adaptation rate for the first beamformer 305 is higher than for the constrained beamformers 309, 311. Thus, in many embodiments, the first adapter 307 may be arranged to adapt faster to variations than the second adapter 313, and thus the first beamformer 305 may be updated faster than the constrained beamformers 309, 311. This may for example be achieved by the low pass filtering of a value being maximized or minimized (e.g. the signal level of the output signal or the magnitude of an error signal) having a higher cut-off frequency for the first beamformer 305 than for the constrained beamformers 309, 311. As another example, a maximum change per update of the beamform parameters (specifically the beamform filter coefficients) may be higher for the first beamformer 305 than for the constrained beamformers 309, 311.

Accordingly, in the system, a plurality of focused (adaptation constrained) beamformers that adapt slowly and only when a specific criterion is met is supplemented by a free running faster adapting beamformer that is not subject to this constraint. The slower and focused beamformers will typically provide a slower but more accurate and reliable adaptation to the specific audio environment than the free running beamformer which however will typically be able to quickly adapt over a larger parameter interval.

In the system of FIG. 3, these beamformers are used synergistically together to provide improved performance as will be described in more detail later.

The first beamformer 305 and the constrained beamformers 309, 311 are coupled to an output processor 315 which receives the beamformed audio output signals from the beamformers 305, 309, 311. The exact output generated from the audio capturing apparatus will depend on the specific preferences and requirements of the individual embodiment. Indeed, in some embodiments, the output from the audio capturing apparatus may simply consist in the audio output signals from the beamformers 305, 309, 311.

In many embodiments, the output signal from the output processor 315 is generated as a combination of the audio output signals from the beamformers 305, 309, 311. Indeed, in some embodiments, a simple selection combining may be performed, e.g. selecting the audio output signals for which the signal to noise ratio, or simply the signal level, is the highest.

Thus, the output selection and post-processing of the output processor 315 may be application specific and/or different in different implementations/embodiments. For example, all possible focused beam outputs can be provided, a selection can be made based on a criterion defined by the user (e.g. the strongest speaker is selected), etc.

For a voice control application, for example, all outputs may be forwarded to a voice trigger recognizer which is arranged to detect a specific word or phrase to initialize voice control. In such an example, the audio output signal in which the trigger word or phrase is detected may following the trigger phrase be used by a voice recognizer to detect specific commands.

For communication applications, it may for example be advantageous to select the audio output signal that is strongest and e.g. for which the presence of a specific point audio source has been found.

In some embodiments, post-processing, such as the noise suppression of FIG. 1, may be applied to the output of the audio capturing apparatus (e.g. by the output processor 315). This may improve performance for e.g. voice communication. In such post-processing, non-linear operations may be included although it may e.g. for some speech recognizers be more advantageous to limit the processing to only include linear processing.

In the system of FIG. 3, a particularly advantageous approach is taken to capture audio based on the synergistic interworking and interrelation between the first beamformer 305 and the constrained beamformers 309, 311.

For this purpose, the audio capturing apparatus comprises a difference processor 317 which is arranged to determine a difference measure between one or more of the constrained beamformers 309, 311 and the first beamformer 305. The difference measure is indicative of a difference between the beams formed by respectively the first beamformer 305 and the constrained beamformer 309, 311. Thus, the difference measure for a first constrained beamformer 309 may indicate the difference between the beams that are formed by the first beamformer 305 and by the first constrained beamformer 309. In this way, the difference measure may be indicative of how closely the two beamformers 305, 309 are adapted to the same audio source.

Different difference measures may be used in different embodiments and applications.

In some embodiments, the difference measure may be determined based on the generated beamformed audio output from the different beamformers 305, 309, 311. As an example, a simple difference measure may simply be generated by measuring the signal levels of the output of the first beamformer 305 and the first constrained beamformer 309 and comparing these to each other. The closer the signal levels are to each other, the lower is the difference measure (typically the difference measure will also increase as a function of the actual signal level of e.g. the first beamformer 305).

A more suitable difference measure may in many embodiments be generated by determining a correlation between the beamformed audio output from the first beamformer 305 and the first constrained beamformer 309. The higher the correlation value, the lower the difference measure.

Alternatively or additionally, the difference measure may be determined on the basis of a comparison of the beamform parameters of the first beamformer 305 and the first constrained beamformer 309. For example, the coefficients of the beamform filter of the first beamformer 305 and the beamform filter of the first constrained beamformer 309 for a given microphone may be represented by two vectors. The magnitude of the difference vector of these two vectors may then be calculated. The process may be repeated for all microphones and the combined or average magnitude may be determined and used as a difference measure. Thus, the generated difference measure reflects how different the coefficients of the beamform filters are for the first beamformer 305 and the first constrained beamformer 309, and this is used as a difference measure for the beams.

Thus, in the system of FIG. 3, a difference measure is generated to reflect a difference between the beamform parameters of the first beamformer 305 and the first constrained beamformer 309 and/or a difference between the beamformed audio outputs of these.

It will be appreciated that generating, determining, and/or using a difference measure is directly equivalent to generating, determining, and/or using a similarity measure. Indeed, one may typically be considered to be a monotonically decreasing function of the other, and thus a difference measure is also a similarity measure (and vice versa) with typically one simply indicating increasing differences by increasing values and the other doing this by decreasing values.

The difference processor 317 is coupled to the second adapter 313 and provides the difference measure to this. The second adapter 313 is arranged to adapt the constrained beamformers 309, 311 in response to the difference measure. Specifically, the second adapter 313 is arranged to adapt constrained beamform parameters only for constrained beamformers for which a difference measure has been determined that meets a similarity criterion. Thus, if no difference measure has been determined for a given constrained beamformers 309, 311, or if the determined difference measure for the given constrained beamformer 309, 311 indicates that the beams of the first beamformer 305 and the given constrained beamformer 309, 311 are not sufficiently similar, then no adaptation is performed.

Thus, in the audio capturing apparatus of FIG. 3, the constrained beamformers 309, 311 are constrained in the adaptation of the beams. Specifically, they are constrained to only adapt if the current beam formed by the constrained beamformer 309, 311 is close to the beam that the free running first beamformer 305 is forming, i.e. the individual constrained beamformer 309, 311 is only adapted if the first beamformer 305 is currently adapted to be sufficiently close to the individual constrained beamformer 309, 311.

The result of this is that the adaptation of the constrained beamformers 309, 311 are controlled by the operation of the first beamformer 305 such that effectively the beam formed by the first beamformer 305 controls which of the constrained beamformers 309, 311 is (are) optimized/adapted. This approach may specifically result in the constrained beamformers 309, 311 tending to be adapted only when a desired audio source is close to the current adaptation of the constrained beamformer 309, 311.

The approach of requiring similarity between the beams in order to allow adaptation has in practice been found to result in a substantially improved performance when the desired audio source, the desired speaker in the present case, is outside the reverberation radius. Indeed, it has been found to provide highly desirable performance for, in particular, weak audio sources in reverberant environments with a non-dominant direct path audio component.

In many embodiments, the constraint of the adaptation may be subject to further requirements.

For example, in many embodiments, the adaptation may be a requirement that a signal to noise ratio for the beamformed audio output exceeds a threshold. Thus, the adaptation for the individual constrained beamformer 309, 311 may be restricted to scenarios wherein this is sufficiently adapted and the signal on basis of which the adaptation is based reflects the desired audio signal.

It will be appreciated that different approaches for determining the signal to noise ratio may be used in different embodiments. For example, the noise floor of the microphone signals can be determined by tracking the minimum of a smoothed power estimate and for each frame or time interval the instantaneous power is compared with this minimum. As another example, the noise floor of the output of the beamformer may be determined and compared to the instantaneous output power of the beamformed output.

In some embodiments, the adaptation of a constrained beamformer 309, 311 is restricted to when a speech component has been detected in the output of the constrained beamformer 309, 311. This will provide improved performance for speech capture applications. It will be appreciated that any suitable algorithm or approach for detecting speech in an audio signal may be used.

It will be appreciated that the system typically operates using a frame or block processing. Thus, consecutive time intervals or frames are defined, and the described processing may be performed within each time interval. For example, the microphone signals may be divided into processing time intervals, and for each processing time interval the beamformers 305, 309, 311 may generate a beamformed audio output signal for the time interval, determine a difference measure, select a constrained beamformers 309, 311, and update/adapt this constrained beamformer 309, 311 etc. Processing time intervals may in many embodiments advantageously have a duration between 5 msec and 50 msec

It will be appreciated that in some embodiments, different processing time intervals may be used for different aspects and functions of the audio capturing apparatus. For example, the difference measure and selection of a constrained beamformer 309, 311 for adaptation may be performed at a lower frequency than e.g. the processing time interval for beamforming.

In many embodiments, the adaptation may be in dependence on the detection of point audio sources in the beamformed audio outputs. Accordingly, in many embodiments, the audio apparatus may be arranged to detect audio sources as part of the control of the beamformers. In many embodiments, the audio apparatus may specifically be arranged to detect point audio sources in the second beamformed audio outputs.

An audio point source in acoustics is a sound that originates from a point in space. It will be appreciated that the audio apparatus may use different algorithms or criteria for estimating (detecting) whether a point audio source is present in the beamformed audio output from a given constrained beamformer 309, 311 and that the skilled person will be aware of various such approaches.

An approach may specifically be based on identifying characteristics of a single or dominant point source captured by the microphones of the microphone array 301. A single or dominant point source can e.g. be detected by looking at the correlation between the signals on the microphones. If there is a high correlation then a dominant point source is considered to be present. If the correlation is low then it is considered that there is not a dominant point source but that the captured signals originate from many uncorrelated sources. Thus, in many embodiments, a point audio source may be considered to be a spatially correlated audio source, where the spatial correlation is reflected by the correlation of the microphone signals.

In the present case, the correlation is determined after the filtering by the beamform filters. Specifically, a correlation of the output of the beamform filters of the constrained beamformers 309, 311 may be determined, and if this exceeds a given threshold, a point audio source may be considered to have been detected.

In other embodiments, a point source may be detected by evaluating the content of the beamformed audio outputs. For example, the audio source detector 401 may analyse the beamformed audio outputs, and if a speech component of sufficient strength is detected in a beamformed audio output this may be considered to correspond to a point audio source, and thus the detection of a strong speech component may be considered to be a detection of a point audio source.

The detection result is passed to the second adapter 313 which is arranged to adapt the adaptation in response to this. Specifically, the second adapter 313 may be arranged to adapt only constrained beamformers 309, 311 for which the audio source detector 401 indicates that a point audio source has been detected.

Thus, the audio capturing apparatus is arranged to constrain the adaptation of the constrained beamformers 309, 311 such that only constrained beamformers 309, 311 are adapted in which a point audio source is present in the formed beam, and the formed beam is close to that formed by the first beamformer 305. Thus, the adaptation is typically restricted to constrained beamformers 309, 311 which are already close to a (desired) point audio source. The approach allows for a very robust and accurate beamforming that performs exceedingly well in environments where the desired audio source may be outside a reverberation radius. Further, by operating and selectively updating a plurality of constrained beamformers 309, 311, this robustness and accuracy may be supplemented by a relatively fast reaction time allowing quick adaptation of the system as a whole to fast moving or newly occurring sound sources.

In many embodiments, the audio capturing apparatus may be arranged to only adapt one constrained beamformer 309, 311 at a time. Thus, the second adapter 313 may in each adaptation time interval select one of the constrained beamformers 309, 311 and adapt only this by updating the beamform parameters.

The selection of a single constrained beamformers 309, 311 will typically occur automatically when selecting a constrained beamformer 309, 311 for adaptation only if the current beam formed is close to that formed by the first beamformer 305 and if a point audio source is detected in the beam.

However, in some embodiments, it may be possible for a plurality of constrained beamformers 309, 311 to simultaneously meet the criteria. For example, if a point audio source is positioned close to regions covered by two different constrained beamformers 309, 311 (or e.g. it is in an overlapping area of the regions), the point audio source may be detected in both beams and these may both have been adapted to be close to each other by both being adapted towards the point audio source.

Thus, in such embodiments, the second adapter 313 may select one of the constrained beamformers 309, 311 meeting the two criteria and only adapt this one. This will reduce the risk that two beams are adapted towards the same point audio source and thus reduce the risk of the operations of these interfering with each other.

Indeed, adapting the constrained beamformers 309, 311 under the constraint that the corresponding difference measure must be sufficiently low and selecting only a single constrained beamformers 309, 311 for adaptation (e.g. in each processing time interval/frame) will result in the adaptation being differentiated between the different constrained beamformers 309, 311. This will tend to result in the constrained beamformers 309, 311 being adapted to cover different regions with the closest constrained beamformer 309, 311 automatically being selected to adapt/follow the audio source detected by the first beamformer 305. However, in contrast to e.g. the approach of FIG. 2, the regions are not fixed and predetermined but rather are dynamically and automatically formed.

It should also be noted that the regions may be dependent on the beamforming for a plurality of paths and are typically not limited to angular direction of arrival regions. For example, regions may be differentiated based on the distance to the microphone array. Thus, the term region may be considered to refer to positions in space at which an audio source will result in adaptation that meets similarity requirement for the difference measure. It thus includes consideration of not only the direct path but also e.g. reflections if these are considered in the beamform parameters and in particular are determined based on both spatial and temporal aspect (and specifically depend on the full impulse responses of the beamform filters).

The selection of a single constrained beamformer 309, 311 may specifically be in response to a captured audio level. For example, the audio source detector 401 may determine the audio level of each of the beamformed audio outputs from the constrained beamformers 309, 311 that meet the criteria, and it may select the constrained beamformer 309, 311 resulting in the highest level. In some embodiments, the audio source detector 401 may select the constrained beamformer 309, 311 for which a point audio source detected in the beamformed audio output has the highest value. For example, the audio source detector 401 may detect a speech component in the beamformed audio outputs from two constrained beamformers 309, 311 and proceed to select the one having the highest level of the speech component.

In the approach, a very selective adaptation of the constrained beamformers 309, 311 is thus performed leading to these only adapting in specific circumstances. This provides a very robust beamforming by the constrained beamformers 309, 311 resulting in improved capture of a desired audio source. However, in many scenarios, the constraints in the beamforming may also result in a slower adaptability and indeed may in many situations result in new audio sources (e.g. new speakers) not being detected or only being very slowly adapted to.

In the approach, the beamformers 305, 309, 311 do not operate directly on the microphone signals but rather on modified signals resulting from a decorrelation operation by the adaptive spatial decorrelator 303. However, counterintuitively, despite the adaptive spatial decorrelator 303 removing the direct link between the spatial positions of the captured audio and the audio signals on which beamforming is being performed, the beamforming approach and algorithms provide highly advantageous performance and in particular provides a very efficient audio source, and specifically speaker, extraction/isolation/selection. Indeed, the spatial decorrelation by the adaptive spatial decorrelator 303 in many scenarios substantially improves the performance of the beamforming algorithms and often allows an improved separation and isolation of a desired audio source. In particular, the approach may often provide a substantially reduced sensitivity to the presence of a strong or dominant interfering or undesired audio source. Indeed, it has been found that the approach may allow separation and extraction of desired audio sources in situations where the audio scene and captured audio may be dominated by a noise source that may be captured with a substantially higher level than the desired audio source.

As a specific example, the described beamforming approach and arrangement using a (typically fast) free running beamformer 305 combined with multiple constrained beamformers 309, 311 may provide excellent performance in many scenarios, but may sometimes be less efficient in some scenarios where a continuous point noise interferer is strong in comparison to the direct field contribution of the desired speech source(s) on the microphones. An example is when a TV is playing relatively close to the microphone array, and where commands of a desired speaker have to be recognized. The TV loudspeaker signals will typically not be available to the audio apparatus which therefore cannot apply echo cancellation. Such a scenario is highly important for many speech control/interface applications, such as for voice controlled personal devices, or for many communication applications. This may not only degrade the individual beamforming experience but may also affect the interaction between the unconstrained and the constrained beamformers. In particular, the unconstrained beamformer will often only be able to detect and track the strong interferer, and therefore other speaker sources cannot be detected and transferred to the constrained beamformers even if these in principle would be able to extract and track the individual speaker sources. This may result in no constrained beamformers being assigned to the active speakers. However, the introduction of the adaptive spatial decorrelator 303 may result in a decorrelation of this strong interference which can result in the interferer appearing more as uncorrelated noise on the inputs to the beamformers. This may allow improved beamforming which may result in improved isolation and separation of desired sources, and in particular may allow the unconstrained beamformer to detect other audio sources than the strong interferer.

Thus, a strong synergistic effect may be achieved in many scenarios by the beamformers not operating directly on spatial audio signals corresponding to positions in the audio scene, but rather on signals that do not have specific relation to such positions (and indeed with the spatial properties associated with the signals fed to the beamformers varying between different parts and frequency ranges).

The audio apparatus comprises a third adapter 319 which is arranged to dynamically adapt the adaptive spatial decorrelator 303 to provide a suitable decorrelation. The adaptive spatial decorrelator 303 is arranged to adapt the coefficients of the spatial filtering in dependence on update values that are determined from the input signals. For example, the processing may be performed in segments, and in each segment a new update value for the coefficients of the filters may be determined. The coefficients for the subsequent segment may then be modified based on the update values. The adaptive spatial decorrelator 303 may specifically comprise a set of filters with each filter generating the output value as a weighted combination of the input signals, and the third adapter 319 may be arranged to adapt/update the weights of the weighted combination.

The third adapter 319 is arranged to determine the update values such that they reduce correlation of the second set of audio signals, and specifically may be arranged to decorrelate an audio source, such as a dominant audio source.

It will be appreciated that different approaches for adaptively decorrelating a set of (spatial) audio signals are known and that any suitable approach may be used without detracting from the invention. In the following an approach of decorrelation and adaptation will be described which has been found to provide particularly advantageous performance for the audio apparatus of FIG. 3 and specifically for the processing by the beamformers.

The beamforming, decorrelation, and adaptation may typically be performed in the frequency domain. The receiver 301 or adaptive spatial decorrelator 303 may comprise a segmenter which is arranged to segment the set of input audio signals into time segments. In many embodiments, the segmentation may typically be a fixed segmentation into time segments of a fixed and equal duration such as e.g. a division into time segments/intervals with a fixed duration of between 10-20 msecs. In some embodiments, the segmentation may be adaptive for the segments to have a varying duration. For example, the input audio signals may have a varying sample rate and the segments may be determined to comprise a fixed number of samples.

The segmentation may typically be into segments with a given fixed number of time domain samples of the input signals. For example, in many embodiments, the segmenter 103 may be arranged to divide the input signals into consecutive segments of e.g., 256 or 512 samples.

The receiver 301 or adaptive spatial decorrelator 303 may be arranged to generate a frequency bin representation of the input audio signals and the first set of input signals further processed are typically represented in the frequency domain by a frequency bin representation. The audio apparatus may be arranged to perform frequency domain processing of the frequency domain representation of the input audio signals. The signal representation and processing are based on frequency bins and thus the signals are represented by values of frequency bins and these values are processed to generate frequency bin values of the output signals. In many embodiments, the frequency bins have the same size, and thus cover frequency intervals of the same size. However, in other embodiments, frequency bins may have different bandwidths, and for example a perceptually weighted bin frequency interval may be used.

In some embodiments, the input audio signals may already be provided in a frequency representation and no further processing or operation is required. In some such cases, however, a rearrangement into suitable segment representations may be desired, including e.g. using interpolation between frequency values to align the frequency representation to the time segments.

In other embodiments, a filter bank, such as a Quadrature Mirror Filter, QMF, may be applied to the time domain input signals to generate the frequency bin representation. However, in many embodiments, a Discrete Fourier Transform (DFT) and specifically a Fast Fourier Transform, (FFT) may be applied to generate the frequency representation.

In the audio apparatus of FIG. 3, the adaptive spatial decorrelator 303 may comprise spatial decorrelation filters that process the first set of audio signals in the frequency domain. In the following description, the first set of audio signals may also be referred to as input audio signals (to the adaptive spatial decorrelator 303) and the resulting signals (the second set of audio signals) may also be referred to as output audio signals (from the adaptive spatial decorrelator 303).

For each frequency bin, an output frequency bin value is generated from one or more input frequency bin values of one or more input signals as will be described in more detail in the following. The output signals are generated to (typically/on average) reduce the correlation between signals relative to the correlation of the input signals, at least for one audio source which for example may be a dominant audio source.

The spatial decorrelation filter set is arranged to filter the input audio signals. The filtering is a spatial filtering in that for a given output signal, the output value is determined from a plurality of, and typically all of the input audio signals (for the same time/segment and for the same frequency bin). The spatial filtering is specifically performed on a frequency bin basis such that a frequency bin value for a given frequency bin of an output signal is generated from the frequency bin values of the input signals for that frequency bin. The filtering/weighted combination is across the signals rather than being a typical time/frequency filtering.

Specifically, the frequency bin value for a given frequency bin is determined as the weighted combination of the frequency bin values of the input signals for that frequency bin. The combination may specifically be a summation and the frequency bin value may be determined as a weighted summation of the frequency bin values of the input signals for that frequency bin. The determination of a bin value for a given frequency bin may be determined as the vector multiplication of a vector of the weights/coefficients of the weighted summation and a vector comprising the bin values of the input signals:

$$[ y ] = [ {w}_{1} {w}_{2} {w}_{3} ] [ \begin{matrix}{x}_{1} \\ {x}_{2} \\ {x}_{3}\end{matrix} ]$$

where y is the output bin value, w₁-w₃ are the weights of the weighted combination, and x₁-x₃ are the input signal bin values.

Representing the output bin values for a given frequency bin ω as a vector y(ω), the determination of the output signals may be determined as:

y(ω)=W(ω)x(ω)
where the matrix W(ω) represents the weights/coefficients of the weighted summation for the different output signals and x(ω) is a vector comprising the input signal values.

For example, for an example with only three input signals and output signals, the output bin values for the frequency bin ω may be given by

$$[ \begin{matrix}{y}_{1} \\ {y}_{2} \\ {y}_{3}\end{matrix} ] = [ \begin{matrix}{w}_{11} & {w}_{12} & {w}_{13} \\ {w}_{21} & {w}_{22} & {w}_{23} \\ {w}_{31} & {w}_{32} & {w}_{33}\end{matrix} ] [ \begin{matrix}{x}_{1} \\ {x}_{2} \\ {x}_{3}\end{matrix} ]$$

where yₙ represents the output bin values, wᵢⱼ represents the weights of the weighted combinations, and xₘ represents the input signal bin values.

The third adapter 319 may seek to adapt the spatial filters to be spatial decorrelation filters that seek to generate the output signals to correspond to the input signals but with an increased decorrelation of the signals, specifically for one (dominant) audio source. The output audio signals are generated to have an increased spatial decorrelation with the cross correlation between audio signals being lower for the output audio signals than for the input audio signals. Specifically, the output signals may be generated to have the same combined energy/power as the combined energy/power of the input signals (or have a given scaling of this) but with an increased decorrelation (decreased correlation) between the signals. The output audio signals may be generated to include all the audio/signal components of the input signals in the output audio signals but with a re-distribution to different signals to achieve increased decorrelation.

The decorrelation filters may specifically be arranged to generate output signals that have a lower coherence/normalized correlation than the input signals. The output signals of the decorrelation filters may thus have lower coherence/normalized correlation than the coherence in the input signals to the decorrelation filters.

The third adapter 319 is arranged to determine update values for the weights of the weighted combination(s) forming the set of spatial decorrelation filters. Thus, specifically, update values may be determined for the matrix W(ω). The third adapter 319 may then update the weights of the weighted combination based on the update values.

The third adapter 319 is arranged to apply an adaptation approach that determines update values which may allow the output signals of the set of decorrelation filters to represent the audio of the input signals to the set of decorrelation filters but with the output signals typically being more decorrelated than the input signals.

The third adapter 319 is arranged to use a specific approach of adapting the weights based on the generated output signals. The operation is based on each output audio signal being linked with one input audio signal. The exact linking between output signals and input signals is not essential and many different (including in principle random) linkings/pairings of each output signal to an input signal may be used. However, the processing is different for a weight that reflects a contribution from an input signal that is linked to/paired with the output signal for the weight than the processing for a weight that reflects a contribution from an input signal that is not linked to/paired with the output signal for the weight. For example, in some embodiments, the weights for linked signals (i.e. for input signals that are linked to the output signal generated by the weighted combination that includes the weight) may be set to a fixed value and not updated, and/or the weights for linked signals may be restricted to be real valued weights whereas other weights are generally complex values.

The third adapter 319 uses an adaptation/update approach where an update value is determined for a given weight that represents the contribution to a bin value for a given output signal from a given non-linked input signal based on a correlation measure between the output bin value for the given output signal and the output bin value for the output signal that is linked with the given (non-linked) input signal. The update value may then be applied to modify the given weight in the subsequent segment, or the update value for weight in a given segment is determined in response to two output bin values of a (and typically the immediate) prior segment, where the two output values represent respectively the input signal and the output signal to which the weight relate.

The described approach is typically applied to a plurality, and typically all, of the weights used in determining the output bin values based on a non-linked input signal. For weights relating to the input signal that is linked to the output signal for the weight, other considerations may be used, such as e.g. setting the weight to a fixed value as will be described in more detail later.

Specifically, the update value may be determined in dependence on a product of the output bin value for the weight and the complex conjugate of the output bin value linked to the input signal for the weight, or equivalently in dependence on a product of the complex conjugate of the output bin value for the weight and the output bin value linked to the input signal for the weight.

As a specific example, an update value for segment k+1 for frequency bin ω may be determined in dependence on the correlation measure given by:

$$[ {y}_{i} ( k , ω ) {y}_{j}^{*} ( k , ω ) ]$$

or equivalently by:

$$[ {y}_{i}^{*} ( k , ω ) {y}_{j} ( k , ω ) ]$$

where yᵢ(k, ω) is the output bin value for the output signal i being determined based on the weight; and yⱼ(k, ω) is the output bin value for the output signal j that is linked to the input signal from which the contribution is determined (i.e. the input signal bin value that is multiplied by the weight to determine a contribution to the output bin value for signal i).

The measure of

$$[ {y}_{i} ( k , ω ) {y}_{j}^{*} ( k , ω ) ]$$

(or the conjugate value) indicates the correlation of the time domain signal in the given segment. In the specific example, this value may then be used to update and adapt the weight w_{i,j}(k+1,0).

As previously mentioned, the set of decorrelation filters may be arranged to determine the output bin values for the output signals for the given frequency bin ω from:

y(ω)=W(ω)x(ω)
where y(ω) is a vector comprising the frequency bin values for the output signals for the given frequency bin ω; x(ω) is a vector comprising the frequency bin values for the input audio signals for the given frequency bin ω; and W(ω) is a matrix having rows comprising weights of a weighted combination for the output audio signals.

In the example, third adapter 319 may specifically be arranged to adapt at least some of the weights wᵢⱼ of the matrix W(ω) according to:

$${w}_{ij} ( k + 1 , ω ) = {w}_{ij} ( k , ω ) - η ( k , ω ) [ {y}_{i} ( k , ω ) {y}_{j}^{*} ( k , ω ) ]$$

where i is a row index of the matrix W(ω), j is a column index of the matrix W(ω), k is a time segment index, ω represents the frequency bin, and η(k, ω) is a scaling parameter for adapting an adaptation speed. Typically, the third adapter 319 may be arranged to adapt all the weights that are not relating the input signal with the linked output signal (i.e. “cross-signal” weights).

In some embodiments, the third adapter 319 may be arranged to adapt the update rate/speed of the adaptation of the weights. For example, in some embodiments, the adapter may be arranged to compensate the correlation measure for a given weight in dependence on the signal level of the output bin value to which a contribution is determined by the weight.

As a specific example, the compensation value

$$[ {y}_{i} ( k , ω ) {y}_{j}^{*} ( k , ω ) ]$$

may be compensated by the signal level of the output bin value, |yᵢ(k, ω)|. The compensation may for example be included to normalize the update step values to be less dependent on the signal level of the generated decorrelated signals.

In many embodiments, such a compensation or normalization may specifically be performed on a frequency bin basis, i.e. the compensation may be different in different frequency bins. This may in many scenarios improve the operation and may typically result in an improved adaptation of the weights generating the decorrelated signals.

The compensation may for example be built into the scaling parameter η(k, ω) of the previous update equation. Thus, in many embodiments, the third adapter 319 may be arranged to adapt/change the scaling parameter η(k, ω) differently in different frequency bins.

In many embodiments, the arrangement of the input signal vector x(ω) the output signal vector y(ω) is such that linked signals are at the same position in the respective vectors, i.e. specifically y₁ is linked with x₁, y₂ with x₂, y₃ is with x₃, etc. In this case, the weights for the linked signals are on the diagonal of the weight matrix W(k, ω). The diagonal values may in many embodiments be set to a fixed real value, such as e.g. specifically be set to a constant value of 1.

In many embodiments, the weights/spatial filters/weighted combinations may be such that the weights for a contribution to a first output signal from a first input signal (not linked to the first output signal) is a complex conjugate of the contribution to a second output signal being linked with the first input signal from a second input signal being linked with the first input signal. Thus, the two weights for two pairs of linked input/output signals are complex conjugates.

In the example of the weights for linked input and output signals being arranged on the diagonal of the weight matrix W(ω), this results in a Hermitian matrix. Indeed, in many embodiments, the weight matrix W(ω) is a Hermitian matrix. Specifically, the coefficients/weights of the weight matrix W(ω) may meet the criterion:

$${w}_{ij} = {w}_{ji}^{*} .$$

As previously mentioned, the weights for the contributions to an output signal bin value from the linked input signal (corresponding to the values of the diagonal of the weight matrix W(ω) in the specific example) are treated differently than the weights for non-linked input signals. The weights for linked input signals will in the following for brevity also be referred to as linked weights and the weights for non-linked input signals will in the following for brevity also be referred to as non-linked weights, and thus in the specific example the weight matrix W(ω) will be a Hermitian matrix comprising the linked weights on the diagonal and the non-linked weights outside the diagonal.

In many approaches, the adaptation of the non-linked weights is such that it seeks to reduce the correlation measures. Specifically, each update value may be determined to reduce the correlation measure. Overall, the adaptation will accordingly seek to reduce the cross-correlations between the output signals. However, the linked weights are determined differently to ensure that the output signals maintain a suitable audio energy/power/level. Indeed, if the linked weights where instead adapted to seek to reduce the autocorrelation of the output signal for the weight, there is a high risk that the adaptation would converge on a solution where all weights, and thus output signals, are essentially zero (as indeed this would result in the lowest correlations). Further, the audio apparatus is arranged to seek to generate signals with less cross-correlation but do not seek to reduce autocorrelation.

Thus, in many embodiments, the linked weights may be set to ensure that the output signals are generated to have a desirable (combined) energy/power/level.

In some cases, the third adapter 319 may be arranged to adapt the linked weights, and in other cases the adapter may be arranged to not adapt the linked weights.

For example, in some embodiments, the linked weights may simply be set to a fixed constant value that is not adapted. For example, in many embodiments, the linked weights may be set to a constant scalar value, such as specifically to the value 1 (i.e. a unitary gain being applied for a linked input signal). For example, the weights on the diagonal of the weight matrix W(ω) may be set to 1.

Thus, in many embodiments, the weight for a contribution to a given output signal frequency bin value from a linked input signal frequency bin value may be set to a predetermined value. This value may in many embodiments be maintained constant without any adaptation.

Such an approach has been found to provide very efficient performance and may result in an overall adaptation that has been found to provide output signals to be generated that provide a highly accurate representation of the original audio of the input signals but in a set of output signals that have increased decorrelation.

In some embodiments, the linked weights may also be adapted but will be adapted differently than the non-linked weights. In particular, in many embodiments, the linked weights may be adapted based on the output signals.

Specifically, in many embodiments, a linked weight for a first input signal and linked output signal may be adapted based on the generated output bin value of the linked audio signal, and specifically based on the magnitude of the output bin value.

Such an approach may for example allow a normalization and/or setting of the desired energy level for the signals.

In many embodiments, the linked weights are constrained to be real valued weights whereas the non-linked weights are generally complex values. In particular, in many embodiments, the weight matrix W(ω) may be a Hermitian matrix with real values on the diagonal and with complex values outside of the diagonal.

Such an approach may provide a particular advantageous operation and adaptation in many scenarios and embodiments. It has been found to provide a highly efficient spatial decorrelation while maintaining a relatively low complexity and computational resource.

The adaptation may gradually adapt the weights to increase the decorrelation between signals. In many embodiments, the adaptation may be arranged to converge towards a suitable weight matrix W(ω) regardless of the initial values and indeed in some cases the adaptation may be initialized by random values for the weights.

However, in many embodiments, the adaptation may be started with advantageous initial values that may e.g. result in faster adaptation and/or result in the adaptation being more likely to converge towards more optimal weights for decorrelating signals.

In particular, in many embodiments, the weight matrix W(ω) may be arranged with a number of weights being zero but at least some weights being non-zero. In many embodiments, the number of weights being substantially zero may be no less than 2,3,5, or 10 times the number of weights that are set to a non-zero value. This has been found to tend to provide improved adaptation in many scenarios.

In particular, in many embodiments, the third adapter 319 may be arranged to initialize the weights with linked weights being set to a non-zero value, such as typically a predetermined non-zero real value, whereas non-linked weights are set to substantially zero. Thus, in the above example where linked signals are arranged at the same positions in the vectors, this will result in an initial weight matrix W(ω) having non-zero values on the diagonal and (substantially) zero values outside of the diagonal.

Such initializations may provide particularly advantageous performance in many embodiments and scenarios. It may reflect that due to the audio signals typically representing audio at different positions, there is a tendency for the input signals to be somewhat decorrelated. Accordingly, a starting point that assumes the input signals are fully correlated is often advantageous and will lead to a faster and often improved adaptation.

It will be appreciated that the weights, and specifically the non-linked weights, may not necessarily be exactly zero but may in some embodiments be set to low values close to zero. However, the initial non-zero values may be at least 5,10,20 or 100 times higher than the initially substantially zero values.

The described approach may provide a highly efficient adaptive spatial decorrelator that may generate output signals that represent the same audio as the input signals but with increased decorrelation. The approach has in practice been found to provide a highly efficient adaptation in a wide variety of scenarios and in many different acoustic environments and for many different audio sources. For example, it has been found to provide a highly efficient decorrelation of speaker signals in environments with multiple speakers.

The adaptation approach is furthermore computationally efficient and in particular allows localized and individual adaptation of individual weights based only on two signals (and specifically on only two frequency bin values) closely related to the weight, yet the process results in an efficient and often substantially optimized global optimization of the spatial filtering, and specifically the weight matrix W(ω). The local adaptation has been found to lead to a highly advantageous global adaptation in many embodiments.

A particular advantage of the approach is that it may be used to decorrelate convolutive mixtures and is not limited to only decorrelate instantaneous mixtures. For a convolutive mixture, the full impulse response determines how the signals from the different audio sources combine at the microphones (i.e. the delay/timing characteristics are significant) whereas for instantaneous mixes a scalar representation is sufficient to determine how the audio sources combine at the microphones (i.e. the delay/timing characteristics are not significant). By transforming a convolutive mixture into the frequency domain, the mixture can be considered a complex-valued instantaneous mixture per frequency bin.

The third adapter 319 thus determines the coefficients for the set of spatial decorrelation filters of the adaptive spatial decorrelator 303 such that these modify the first set of audio signals to represent the same audio but with an increased decorrelation. Such a decorrelation of the audio signals to which the previously described multibeam beamforming approach is then applied may substantially improve the overall performance in many scenarios. Indeed, it may in many scenarios result in improved separation and selection of a specific audio source, such as a specific speaker. Thus, counterintuitively, the decorrelation of signals may provide improved beamforming performance despite the beamforming inherently being based on exploiting and adapting to correlation between audio signals from different positions to extract/separate an audio source by spatially forming a beam towards the desired source. Indeed, the decorrelation inherently breaks the link between the audio signals and the specific location in the audio scene that is typically exploited by a beamforming operation. However, the Inventors have realized that despite this, the decorrelation may provide highly advantageous effects and improved performance in many scenarios. For example, in the presence of a strong noise source, the approach may facilitate and/or improve the extraction/isolation of a specific desired audio source such as specifically a speaker.

The specific adaptation described above may provide a highly advantageous approach in many embodiments. It may typically provide a low complexity yet highly accurate adaptation to result in spatial decorrelation filters that generate highly decorrelated signals. In particular, it may allow local adaptation of individual weights/filter coefficients to result in a highly efficient global decorrelation of the first set of audio signals.

However, it will be appreciated that in other embodiments, other approaches for adapting the spatial filters/decorrelation filters may be used. For example, in some embodiments, the third adapter 319 may comprise a neural network which based on the input samples is arranged to generate update values for modifying the filter coefficients. For example, for each segment, the frequency bin values for all the audio signals may be fed to a trained neural network which as an output generates an update value for each weight. Each weight may then be updated by this update value. The trained network may for example have been trained by training data that includes many different frequency bin values and associated update values that have manually been determined to modify weights towards increased decorrelation

As another example, the third adapter 319 may comprise a location processor which, based on visual cues related to (changing) positions, is arranged to generate update values for modifying the filter coefficients. As another example, the third adapter 319 may determine the cross-correlation matrix of the input signals and compute its eigenvalue decomposition. The eigenvectors and eigenvalues can be used to construct a decorrelation matrix.

The audio apparatus may be arranged to initialize a constrained beamformer 309, 311 in certain situations. Specifically, the audio apparatus can initialize a constrained beamformer 309, 311 in response to the first beamformer 305, and specifically can initialize one of the constrained beamformers 309, 311 to form a beam corresponding to that of the first beamformer 305. The audio apparatus may be arranged to initialize a constrained beamformer 309, 311 with beamform parameters that match the beamform parameters of the first beamformer 305. Specifically, the constrained beamformer 309, 311 may be initialized with beamform parameters that result in an audio beam being formed in the direction of the audio beam formed by the first beamformer 305. In many embodiments, the audio apparatus may be arranged to initialize the constrained beamformer 309, 311 by copying filter parameters/values of the beamfilter(s) of the first beamformer 305 to the beamfilter(s) of the constrained beamformer 309, 311 being initialized. Thus, the constrained beamformer 309, 311 may be initialized to form an audio beam matching the audio beam of the first beamformer 305.

The initialization may specifically be performed if it is detected that there is no constrained beamformer for which the difference measure meets a proximity/similarity criterion, such as e.g. if it is determined that there is no constrained beamformer that has a difference measure below a given threshold. The initialization may be subject to a detection of an audio source being present in the beam formed by the first beamformer 305. The initialization may be performed if an audio source, such as e.g. a point audio source, is detected in the beamformed audio output signal of the first beamformer 305 and that no constrained beamformer 309, 311 has a difference measure that meets the similarity criterion. The detection of the audio source may be a low complexity determination, such that a determination that a level of the beamformed audio output signal of the first beamformer 305 exceeds a threshold, or may be more complex such as a detection of specific properties such as properties for a specific point audio source.

The audio apparatus specifically sets the beamform parameters of one of the constrained beamformers 309, 311 in response to the beamform parameters of the first beamformer 305, henceforth also referred to as the first beamform parameters. In some embodiments, the filters of the constrained beamformers 309, 311 and the first beamformer 305 may be identical, e.g. they may have the same architecture. As a specific example, both the filters of the constrained beamformers 309, 311 and the first beamformer 305 may be FIR filters with the same length (i.e. a given number of coefficients), and the current adapted coefficient values from filters of the first beamformer 305 may simply be copied to the constrained beamformer 309, 311, i.e. the coefficients of the constrained beamformer 309, 311 may be set to the values of the first beamformer 305. In this way, the constrained beamformer 309, 311 will be initialized with the same beam properties as currently adapted to by the first beamformer 305.

In some embodiments, the setting of the filters of the constrained beamformer 309, 311 may be determined from the filter parameters of the first beamformer 305 but rather than use these directly they may be adapted before being applied. For example, in some embodiments, the coefficients of FIR filters may be modified to initialize the beam of the constrained beamformer 309, 311 to be broader than the beam of the first beamformer 305 (but e.g. being formed in the same direction).

The audio apparatus may in many embodiments accordingly in some circumstances initialize one of the constrained beamformers 309, 311 with an initial beam corresponding to that of the first beamformer 305. The system may then proceed to treat the constrained beamformer 309, 311 as previously described, and specifically may proceed to adapt the constrained beamformer 309, 311 when it meets the previously described criteria.

The criteria for initializing a constrained beamformer 309, 311 may be different in different embodiments.

In many embodiments, the audio apparatus may be arranged to initialize a constrained beamformer 309, 311 if the presence of a point audio source is detected in the first beamformed audio output but not in any constrained beamformed audio outputs.

Thus, the audio apparatus may determine whether a point audio source is present in any of the beamformed audio outputs from either the constrained beamformers 309, 311 or the first beamformer 305. The detection/estimation results for each beamformed audio output may be evaluated. If a point audio source is only detected for the first beamformer 305, but not for any of the constrained beamformers 309, 311, this may reflect a situation wherein a point audio source, such as a speaker, is present and detected by the first beamformer 305, but none of the constrained beamformers 309, 311 have detected or been adapted to the point audio source. In this case, the constrained beamformers 309, 311 may never (or only very slowly) adapt to the point audio source. Therefore, one of the constrained beamformers 309, 311 is initialized to form a beam corresponding to the point audio source. Subsequently, this beam is likely to be sufficiently close to the point audio source and it will (typically slowly but reliably) adapt to this new point audio source.

Thus, the approach may combine and provide advantageous effects of both the fast first beamformer 305 and of the more reliable constrained beamformers 309, 311.

In some embodiments, the audio apparatus may be arranged to initialize the constrained beamformer 309, 311 only if the difference measure for the constrained beamformer 309, 311 exceeds the threshold. Specifically, if the lowest determined difference measure for the constrained beamformers 309, 311 is below the threshold, no initialization is performed. In such a situation, it may be possible that the adaptation of constrained beamformer 309, 311 is closer to the desired situation whereas the less reliable adaptation of the first beamformer 305 is less accurate and may adapt to be closer to the first beamformer 305. Thus, in such scenarios where the difference measure is sufficiently low, it may be advantageous to allow the system to try to adapt automatically.

In some embodiments, the audio apparatus may specifically be arranged to initialize a constrained beamformer 309, 311 when a point audio source is detected for both the first beamformer 305 and for one of the constrained beamformers 309, 311 but the difference measure for these fails to meet a similarity criterion. Specifically, the audio apparatus may be arranged to set beamform parameters for a first constrained beamformer 309, 311 in response to the beamform parameters of the first beamformer 305 if a point audio source is detected both in the beamformed audio output from the first beamformer 305 and in the beamformed audio output from the constrained beamformer 309, 311, and the difference measure these exceeds a threshold.

Such a scenario may reflect a situation in which the constrained beamformer 309, 311 may possibly have adapted to and captured a point audio source that however is different from the point audio source captured by the first beamformer 305. Thus, it may specifically reflect that a constrained beamformer 309, 311 may have captured the “wrong” point audio source. Accordingly, the constrained beamformer 309, 311 may be re-initialized to form a beam towards the desired point audio source.

In some embodiments, the number of constrained beamformers 309, 311 that are active may be varied. For example, the audio capturing apparatus may comprise functionality for forming a potentially relatively high number of constrained beamformers 309, 311. For example, it may implement up to, say, eight simultaneous constrained beamformers 309, 311. However, in order to reduce e.g. power consumption and computational load, not all of these may be active at the same time.

In some embodiments, the audio apparatus may be arranged to differentiate between speech and noise sources that specifically may be non-speech sources. It may specifically be arranged to detect that a strong captured audio source is not speech but is more likely to be a noise or interference source. In particular, in some embodiments, the third adapter 319 may be arranged to designate the constrained beamformed audio output signal of a given constrained beamformer as a speech audio signal or as a noise audio signal (specifically as a non-speech audio signal). For example, when a constrained beamformer is being initialized, the third adapter 319 may be arranged to perform a speech detection on the generated beamformed audio output signal of that constrained beamformer. If it is detected to comprise a sufficiently strong speech component, the output signal is designated as a speech audio signal, and otherwise it is designated as a noise audio signal. Correspondingly the constrained beamformer may be designated as a speech or noise constrained beamformer.

In applications seeking to extract and isolate speech, the approach may accordingly separate between the audio source detected by the free running beamformer 305 (and to which a new constrained beamformer is assigned) is a desired speech audio source or if it is a non-desired noise (and typically non-speech) audio source. In many embodiments, the designation of an audio source/audio signal/beam/constrained beamformer as a noise source/signal/beam/constrained beamformer may accordingly also be referred to as a designation as a non-speech source/signal/beam/beamformer and the following description will focus on separation between a speech audio signal and a non-speech audio signal.

The audio apparatus may further be arranged to process and use the generated beamformed output audio signal differently dependent on how it is designated.

Specifically, the third adapter 319 may be arranged to control the adaptation of the adaptive spatial decorrelator 303 to be dependent on a beamformed output audio signal designated as a non-speech audio signal. Specifically, the adaptation and update of the decorrelation coefficients may only be performed when the beamformed output audio signal designated as a non-speech audio signal has a difference measure meeting a proximity criterion, i.e. the third adapter 319 may only update the adaptive spatial decorrelator 303 when the free-running beam is capturing an audio signal that is sufficiently close to the beamformed output audio signal which is considered to be a noise audio signal.

Thus, in some embodiments, the constrained beamformer may be initialized to track/capture a non-speech or noise audio signal, and the adaptive spatial decorrelator 303 may only be updated when the free-running beam captures a matching audio signal. This may achieve the effect that the adaptive spatial decorrelator 303 is updated and adapted specifically to decorrelate the non-speech audio source. This may provide substantially improved performance and has been found to in particularly result in a substantially reduced sensitivity to strong or dominant noise or interfering audio sources in the audio scene.

In some embodiments, the audio apparatus may accordingly be arranged to allocate one (or more) of the constrained beamformers to capture a (typically strong or dominant) noise audio source and use this to control the adaptation of the adaptive spatial decorrelator 303 such that this specifically decorrelates the noise audio source.

It will be appreciated that the initialization of a constrained beamformer as such a noise beamformer may be subject to other requirements similarly to what was described above for initialization of a beamformer. In particular, it may be subject to the level of the audio signal captured by the first beamformer 305 having a sufficiently high level, and indeed in many embodiments may be subject to the level of the signal captured by the first beamformer 305 being higher than for any of the currently active constrained beamformers (thus indicating that a new and strong audio source is detected).

Similarly, the adaptation of the adaptive spatial decorrelator 303, and indeed of the noise beamformer itself, may be subject to various requirements as described above. In particular, it may be subject to criteria including a requirement that a level of the constrained beamformed audio output signal is higher than for any other constrained beamformer; a requirement that a level of a constrained beamformed audio output signal exceeds a given threshold; a requirement that a level of a point audio source in the constrained beamformed audio output signal is higher than for any point audio source in any other constrained beamformed audio output signal, and/or a requirement that a signal to noise ratio for the constrained beamformed audio output signal exceeds a threshold.

In many embodiments, the output processor 315 is arranged to generate the output audio signal to not include a contribution from a beamformed output audio signal that is designated as a non-speech audio signal. Thus, the output signal of the audio apparatus does not include any component from the beamformer output audio signal(s) that is (are) considered to be focused on noise sources. In many embodiments, the audio apparatus may accordingly include one or more constrained beamformers which is allocated purely to capturing a noise source for the purpose of using this to control the adaptation of the adaptive spatial decorrelator 303 such that this may specifically be adapted to decorrelate the noise source. The constrained beamformer, and the beamformer output audio signals, may be used for only this purpose.

It will be appreciated that many different techniques and approaches are known for detecting and classifying audio signals as speech audio signals or non-speech audio signals and that any suitable approach may be used without detracting from the invention.

However, an issue with many such suitable algorithms and techniques is that they tend to be relatively slow and require an averaging over some time before accurate results can be determined. Typically, several seconds are required for an accurate determination, and such a delay before processing a new audio source may often be disadvantageous in e.g. teleconferencing applications.

As described, in many embodiments, the audio apparatus may be arranged to initialize a constrained beamformer when a new source is detected by the first beamformer 305, and specifically in many embodiments dependent on the signal level of the free-running beamformed output audio signal and on the difference measures. In particular, if the signal level of the free-running beamformed signal exceeds a threshold, and in some cases specifically that it has the highest level of any beamformed signal, and that there is no constrained beamformer which has a difference measure below a given threshold (indicating that a new audio source is detected), then a new constrained beamformer may be initialized to track the new audio source.

In many embodiments, the third adapter 319 may be arranged to initially designate the resulting constrained beamformed audio output signal of the given constrained beamformer as speech audio signal. Thus, specifically, whenever a new constrained beamformer is initialized, it is designated as generating a speech audio signal. This designation may be given initially without any consideration of any properties of the generated audio signal, and indeed all initializations may result in the beamformer output audio signals being designated as a speech audio signal. Thus, initially, any new signal from a constrained beamformer may be included in the output signal and the adaptation of the adaptive spatial decorrelator 303 is not adapted to specifically decorrelate this signal.

The third adapter 319 may then proceed to apply speech detection to the new beamformed output audio signal to determine whether indeed it does correspond to a capture of a speech audio signal. If so, the third adapter 319 proceeds with the beamformed output audio signal being designated as a speech audio signal, and thus being included in the output signal. If the speech detection does not result in a detection of speech at a desired level (in accordance with any suitable criterion), the third adapter 319 is arranged to redesignate the beamformer output audio signal from being designated as a speech audio signal to being designated as a non-speech audio signal. Thus, the redesignation from a speech audio signal to a non-speech audio signal may specifically be done in response to a detection that the beamformed output audio signal does not comprise a speech signal component having a level above a threshold. Thus, if no speech is detected (or if the speech that is detected is quiet e.g. in comparison to other audio components of the beamformer output audio signal), then the third adapter 319 changes the designation of the beamformer output audio signal from being a speech audio signal to being a non-speech audio signal, and specifically it is redesignated from a speech audio signal to a noise audio signal. As a result, the beamformed output audio signal may be removed from the output signal generated by the output processor 315 and instead be used to adapt the adaptive spatial decorrelator 303 to result in this being adapted to decorrelate the audio noise source that is captured by the beamformed output audio signal.

In some embodiments, the audio apparatus may accordingly be arranged to initially when a new audio source is detected, treat it as a speech audio signal and include it in the output signal etc. However, if it is subsequently determined that the audio source is a non-speech audio source, it is redesignated to be treated as a noise audio signal. Such an approach may in particular mitigate detrimental effects of delays in performing speech detection. Typically, a substantial delay of sometimes several seconds is associated with performing reliable speech detection (mainly due to the temporal dynamics of speech), and delaying the processing of a new audio source until it is determined whether it indeed provides desired or undesired audio (specifically speech or non-speech) would result in a significant delay before desired audio could be heard by a remote end. In the described approach, this is mitigated by initializing a constrained beamformer 309, 311 to a new audio signal such that it is considered to form a candidate or temporary beam/beamformed output audio signal. During an initial time interval, where it is determined whether the candidate beamformed output audio signal is a speech or noise audio signal, the beamformed output audio signal is considered/designated as a speech audio signal, and thus is included in the output signal. This may in some cases add undesired noise to the output signal but may prevent a delay at speech onset before the speaker can be heard at the remote end. Thus, a much preferred user experience can be achieved.

Counterintuitively, the audio apparatus in these embodiments comprise a constrained beamformer which is directed to generate a beamformed output audio signal representing a noise source, and accordingly it seeks to correlate received signal components for the noise audio source from the different signals. However, the adaptive spatial decorrelator 303 is specifically adapted (under the control of the generated beamformed output audio signal) to decorrelate the noise audio source thereby to some extent seeking to achieve the opposite of the noise constrained beamformer. However, it has been found that the two operations advantageously and synergistically interact to allow the decorrelator to decorrelate the noise audio signal to allow improved extraction of speech audio signals by other constrained beamformers while still allowed sufficient correlation to remain to allow the noise constrained beamformer to extract a signal representing the noise audio source such that it can be used to control when the adaptation of the adaptive spatial decorrelator 303 is performed.

As a specific example, the audio apparatus may be based on block processing which e.g. for audio signals sampled at 16 kHz may typically correspond to frames of 256 samples. For each frame the outputs of the adaptive spatial decorrelator 303 and the beamformers 305, 309, 311 and the adapters 303, 307, 313, 319 may perform decisions and determine update values. As an example, the audio apparatus may perform the following operation per frame:
1) Calculate the output signals of the adaptive spatial decorrelator 303 and all the beamformers 305, 309, 311.
2) If a candidate beam exists, then the third adapter 319 determines the new state of the candidate beam with three possible outcomes based on the current state of the speech detection:
   a) The beam is determined to be a speech beam and the constrained beamformer and output signal is designated and treated as such.
   b) The beam is determined to be a noise beam and the constrained beamformer and output signal is designated and treated as such.
   c) A sufficiently reliable determination has not yet been made and the beam remains to be treated as a candidate beam which specifically is also designated as a speech beam/signal.
3) It is determined whether the free-running beamformer 305 has detected a new audio source (e.g. there being a sufficiently strong signal and no constrained beamformer 309, 311 has a difference measure below a threshold).
4) If so, a constrained beamformer 309, 311 may be initialized (e.g. if the free-running beamformer 305 generates the strongest signal) and the generated beamform output audio signal is classified as a candidate signal and temporarily designated as a speech audio signal. If there is no available constrained beamformer 309, 311, a currently assigned constrained beamformer 309, 311 may be reassigned to the new signal. The initialization may include the coefficients of the free-running beamformer 305 overriding the coefficients of the selected constrained beamformer 309, 311.
5) It is then determined which of the constrained beamformers 309, 311 is/are allowed to adapt (e.g. only the constrained beamformer 309, 311 with the lowest difference measure) and the corresponding beamform coefficients are updated/adapted.
6) The third adapter 319 evaluates any beamformed output audio signal designated as a non-speech audio signal to determine whether the adaptive spatial decorrelator 303 can be updated. If so, updated decorrelation coefficients are determined.
7) An output signal is determined by the output processor 315 by combining the beamformer output audio signals designated as speech audio signals.

The audio apparatus may thus be arranged to decorrelate the noise and adapt the adapter 207 when a sufficiently strong (point) noise source is present. However, the adaptation of the decorrelation is stopped when speech is present/dominant resulting in the decorrelation being focused on the decorrelation of the noise rather than on speech.

To this end, a noise constrained beamformer 309, 311 is used to generate a noise beamform output audio signal that controls the adaptation of the adapter 207 and which itself is also adapted to the noise. The noise beamform output audio signal is typically not used for any other purpose and is typically not included in the output signal. Despite the decorrelation of the noise source signal, it has been found that there is typically still enough correlation left to let the free running beamformer focus on the noise when only the noise source is present. As soon as a speech source becomes active, the free-running beamformer 305 may typically very quickly track the speech source. In case the free running beamformer is tracking towards an already existing constrained beam, the detection can be made even more sensitive, since the distance to the noise source becomes larger and the distance to the controlled beamformer becomes smaller.

Before using the noise constrained beamformer 309, 311 for update control of the adaptive spatial decorrelator (and the noise constrained beamformer 309, 311 itself), it should be determined whether a detected source found by the free running beamformer 305 is a speech or noise source. Since, depending on the noise characteristics, it may in some cases possibly take several seconds to distinguish speech from noise, a new point noise source that is found by the free running beamformer 305 may be considered as a candidate source and initially may be designated and treated as a normal speech source. However, if it is subsequently detected that the source is a noise source, it is redesignated as such and is typically removed from the output signal and used to control adaptation of the adaptive spatial decorrelator 303.

As described, the third adapter 319 may analyse the beamformed output audio signal of a candidate beam to determine whether it is a speech audio signal or a noise audio signal. Thus, the designation as a speech audio signal or noise audio signal is dependent on properties of the beamformed output audio signal.

In some cases, the third adapter 319 may analyse whether the beamformed output audio signal has specific properties that are known for a given audio source. For example, the frequency spectrum may be determined and if this corresponds more to e.g. white noise than to a speech audio signal, it may be determined that the beamformed output audio signal is a noise audio signal. Alternatively or additionally, the third adapter 319 may detect whether the beamformed output audio signal is a speech audio signal or not e.g. by applying a known speech detection algorithm to the beamformed output audio signal.

A variety of solutions exist for detecting speech, depending on the noise type. If for example it is known that the source is continuously active, an asymmetric smoothing of the output power of the candidate speech beam former may be applied, for example:

P_{zz}(ω,k+1)=αP_{zz}(ω,k)+(1−α)z(ω,k)z*(ω,k)

if (z(ω,k)z*(ω,k)<P_{zz}(ω,k+1)))

then P_{zz}(ω,k+1)=βP_{zz}(ω,k)+(1−β)z(ω,k)z*(ω,k)
with z the output signal of the beamformer and where β<<α, for example α=0.95 and β=0.1

After integration of P_{zz}(ω, k+1) over all or parts of the frequency bands, a decision that the beamformed output audio signal contains noise instead of speech can be taken when the summed value exceeds a certain threshold:

$$noise detect = ( {\sum }_{ω = lb}^{ω = hb} {P}_{zz} ( ω , k + 1 ) > threshold )$$

Here lb and hb are the lower and higher band respectively. In this way, a noise type that varies much more slowly in amplitude and frequency when compared to speech can be distinguished.

In some embodiments, a trained artificial neural network may be used, and it has in practice been found that more noise types can be distinguished with this approach. The artificial neural network may be trained with speech and all types of non-speech and may for each frame provide an indication whether it is noise or speech with 0 a high probability that it is speech, and 1 a high probability that it is noise. In case the noise and speech characteristics are similar, the artificial neural network may provide a lower probability for the noise, for example 0.6. To cope with that the third adapter 319 may not take a decision on a frame basis but decides only after a number of frames. This may result in a delay. When the outputs of the neural net are close to 0 or 1, the decision may be taken faster when compared e.g. to situations where the outputs are closer to 0.5. If the third adapter 319 is not ready to make a decision yet, the status of the beamformer remains candidate speech beam.

In many embodiments, the audio apparatus may comprise a plurality of substantially identical constrained beamformers 309, 311 and one of these may be allocated as a noise constrained beamformer 309, 311 for generating a beamformed output audio signal designated as a noise audio signal. In other embodiments, one constrained beamformer 309, 311 may be specifically allocated as a noise constrained beamformer 309, 311. In such a case, a designation of a given beamformed output audio signal as a noise audio signal may result in a move to the dedicated constrained beamformer 309, 311, e.g. by the beamform coefficients being copied.

The noise constrained beamformer 309, 311 (whether dedicated or dynamically allocated) may be adapted in response to the difference measure for the beamformer. Specifically, the approach described for adaptation of the constrained beamformer 309, 311 in general may also be applied for the noise constrained beamformer 309, 311. Specifically, the noise constrained beamformer 309, 311 may be updated when the difference measure for the noise constrained beamformer 309, 311 is below a threshold (and specifically when it is the lowest overall difference out of all the constrained beamformers 309, 311). In many embodiments, the noise constrained beamformer 309, 311 may simply be adapted/updated when the adaptive spatial decorrelator 303 is adapted/updated, i.e. the noise constrained beamformer 309, 311 may be allowed to adapt when the adaptive spatial decorrelator 303 is allowed to adapt.

Thus, the third adapter 319 may determine whether or not the adaptive spatial decorrelator 303 and the noise constrained beamformer 309, 311 are allowed to update. For this the difference measure may be used but with the difference being calculated between the free-running and the noise beamformers. The difference measure may specifically be bounded between 0.0 (far away from each other) and 1.0 (completely overlap). When the adaptive spatial decorrelator 303 is at the start of convergence, the distance/difference will often be close to 1.0. After convergence, the difference measure will be lower, because of the decorrelation, but still typically high (between 0.8, and 0.9). To cope with this apart from the difference/distance (called nsdist), we can use a smoothed difference/distance n̅s̅d̅i̅s̅t̅ (first order recursively smoothed) and determine the difference: n̅s̅d̅i̅s̅t̅−nsdist. The difference becomes positive when a speech source becomes active and the free running beamformer tracks to the speech source.

So, a specific update rule for the adaptive spatial decorrelator 303 and noise constrained beamformer 309, 311 may be

((n̅s̅d̅i̅s̅t̅−nsdist)<threshold1)

In case there are also controlled speech beams, we can make the update rule even stronger, since the distance for the speech beam becomes larger, when the beam is active. We then get:

((n̅s̅d̅i̅s̅t̅−nsdist+spdist−s̅p̅d̅i̅s̅t̅)<threshold2)
where spdist and s̅p̅d̅i̅s̅t̅ are the distances from the free-running to the active speech beam and recursively averaged distance respectively. As a refinement we can update n̅s̅d̅i̅s̅t̅ when there is only noise, or alternative apply an a-symmetric smoothing (heavy smoothing when adaptive spatial decorrelator 303 update is false). The same is true for s̅p̅d̅i̅s̅t̅, but then the update should take place when speech is active.

In some embodiments, the audio apparatus may comprise: an audio source detector for detecting point audio sources in the beamformed audio outputs; and wherein the second adapter is arranged to adapt constrained beamform parameters only for constrained beamformers for which a presence of a point audio source is detected in the constrained beamformed audio output.

In some embodiments, the audio source detector is further arranged to detect point audio sources in the first beamformed audio output; and the apparatus further comprises a controller arranged to set constrained beamform parameters for a first constrained beamformer in response to beamform parameters of the first beamformer if a point audio source is detected in the first beamformed audio output but not in any constrained beamformed audio outputs.

In some embodiments, the controller is arranged to set the constrained beamform parameters for the first constrained beamformer in response to the beamform parameters of the first beamformer only if a difference measure for the first constrained beamformer exceeds the threshold. In some embodiments, the audio source detector is further arranged to detect audio sources in the first beamformed audio output; and the apparatus further comprises a controller arranged to set constrained beamform parameters for a first constrained beamformer in response to the beamform parameters of the first beamformer if a point audio source is detected in the first beamformed audio output and in a second beamformed audio output from the first constrained beamformer and a difference measure has been determined for the first constrained beamformer which exceeds a threshold.

In some embodiments, the plurality of constrained beamformers is an active subset of constrained beamformers selected from a pool of constrained beamformers, and the controller is arranged to increase a number of active constrained beamformers to include the first constrained beamformer by initializing a constrained beamformer from the pool of constrained beamformers using the beamform parameters of the first beamformer.

In some embodiments, the second adapter is further arranged to only adapt the constrained beamform parameters for a first constrained beamformer if a criterion is met comprising at least one requirement selected from the group of: a requirement that a level of the second beamformed audio output from the first constrained beamformer is higher than for any other second beamformed audio output; a requirement that a level of a point audio source in the second beamformed audio output from the first constrained beamformer is higher than any point audio source in any other second beamformed audio output; a requirement that a signal to noise ratio for the second beamformed audio output from the first constrained beamformer exceeds a threshold; and a requirement that the second beamformed audio output from the first constrained beamformer comprises a speech component.

In some embodiments, the difference processor is arranged to determine the difference measure for a first constrained beamformer to reflect at least one of:
a difference between the first set of parameters and the constrained set of parameters for the first constrained beamformer; and
a difference between the first beamformed audio output and the constrained beamformed audio output from the first constrained beamformer.

In some embodiments, an adaptation rate for the first beamformer is higher than for the plurality of constrained beamformers.

In some embodiments, the first beamformer and the plurality of constrained beamformers are filter-and-combine beamformers.

In some embodiments, the first beamformer is a filter-and-combine beamformer comprising a first plurality of beamform filters each having a first adaptive impulse responses and a second beamformer being a constrained beamformer of the plurality of constrained beamformers is a filter-and-combine beamformer comprising a second plurality of beamform filters each having a second adaptive impulse response; and the difference processor is arranged to determine the difference measure between beams of the first beamformer and the second beamformer in response to a comparison of the first adaptive impulse responses to the second adaptive impulse responses.

In some embodiments, the apparatus further comprises: a noise reference beamformer arranged to generate a beamformed audio output signal and at least one noise reference signal, the noise reference beamformer being one of the first beamformer and the plurality of constrained beamformers; a first transformer for generating a first frequency domain signal from a frequency transform of the beamformed audio output signal, the first frequency domain signal being represented by time frequency tile values; a second transformer for generating a second frequency domain signal from a frequency transform of the at least one noise reference signal, the second frequency domain signal being represented by time frequency tile values; a difference processor arranged to generate time frequency tile difference measures, a time frequency tile difference measure for a first frequency being indicative of a difference between a first monotonic function of a norm of a time frequency tile value of the first frequency domain signal for the first frequency and a second monotonic function of a norm of a time frequency tile value of the second frequency domain signal for the first frequency; a point audio source estimator for generating a point audio source estimate indicative of whether the beamformed audio output signal comprises a point audio source, the point audio source estimator being arranged to generate the point audio source estimate in response to a combined difference value for time frequency tile difference measures for frequencies above a frequency threshold.

In some embodiments, the point audio source estimator is arranged to detect a presence of a point audio source in the beamformed audio output in response to the combined difference value exceeding a threshold.

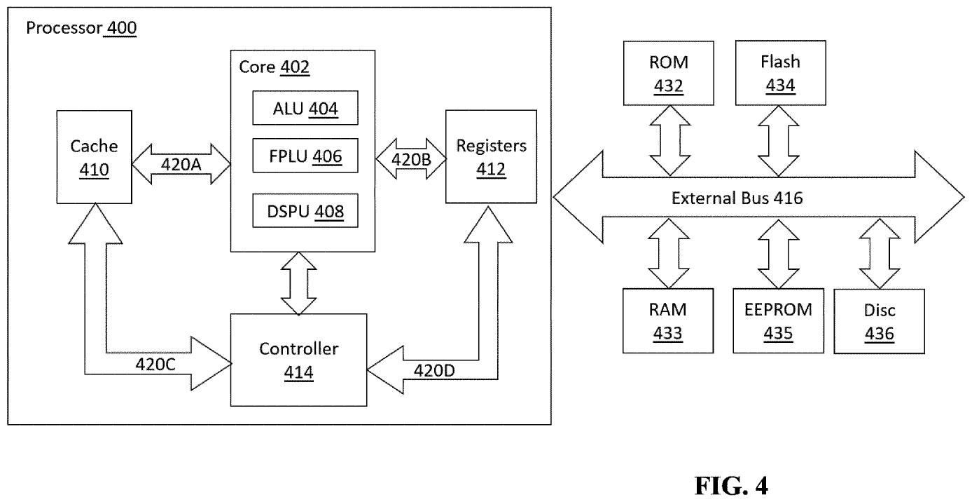

FIG. 4 is a block diagram illustrating an example processor 400 according to embodiments of the disclosure. Processor 400 may be used to implement one or more processors implementing an apparatus as previously described or elements thereof (including in particular one more artificial neural network). Processor 400 may be any suitable processor type including, but not limited to, a microprocessor, a microcontroller, a Digital Signal Processor (DSP), a Field ProGrammable Array (FPGA) where the FPGA has been programmed to form a processor, a Graphical Processing Unit (GPU), an Application Specific Integrated Circuit (ASIC) where the ASIC has been designed to form a processor, or a combination thereof.

The processor 400 may include one or more cores 402. The core 402 may include one or more Arithmetic Logic Units (ALU) 404. In some embodiments, the core 402 may include a Floating Point Logic Unit (FPLU) 406 and/or a Digital Signal Processing Unit (DSPU) 408 in addition to or instead of the ALU 404.

The processor 400 may include one or more registers 412 communicatively coupled to the core 402. The registers 412 may be implemented using dedicated logic gate circuits (e.g., flip-flops) and/or any memory technology. In some embodiments the registers 412 may be implemented using static memory. The register may provide data, instructions and addresses to the core 402.

In some embodiments, processor 400 may include one or more levels of cache memory 410 communicatively coupled to the core 402. The cache memory 410 may provide computer-readable instructions to the core 402 for execution. The cache memory 410 may provide data for processing by the core 402. In some embodiments, the computer-readable instructions may have been provided to the cache memory 410 by a local memory, for example, local memory attached to the external bus 416. The cache memory 410 may be implemented with any suitable cache memory type, for example, Metal-Oxide Semiconductor (MOS) memory such as Static Random Access Memory (SRAM), Dynamic Random Access Memory (DRAM), and/or any other suitable memory technology.

The processor 400 may include a controller 414, which may control input to the processor 400 from other processors and/or components included in a system and/or outputs from the processor 400 to other processors and/or components included in the system. Controller 414 may control the data paths in the ALU 404, FPLU 406 and/or DSPU 408. Controller 414 may be implemented as one or more state machines, data paths and/or dedicated control logic. The gates of controller 414 may be implemented as standalone gates, FPGA, ASIC or any other suitable technology.

The registers 412 and the cache 410 may communicate with controller 414 and core 402 via internal connections 420A, 420B, 420C and 420D. Internal connections may be implemented as a bus, multiplexer, crossbar switch, and/or any other suitable connection technology.

Inputs and outputs for the processor 400 may be provided via a bus 416, which may include one or more conductive lines. The bus 416 may be communicatively coupled to one or more components of processor 400, for example the controller 414, cache 410, and/or register 412. The bus 416 may be coupled to one or more components of the system.

The bus 416 may be coupled to one or more external memories. The external memories may include Read Only Memory (ROM) 432. ROM 432 may be a masked ROM, Electronically

Programmable Read Only Memory (EPROM) or any other suitable technology. The external memory may include Random Access Memory (RAM) 433. RAM 433 may be a static RAM, battery backed up static RAM, Dynamic RAM (DRAM) or any other suitable technology. The external memory may include Electrically Erasable Programmable Read Only Memory (EEPROM) 435. The external memory may include Flash memory 434. The External memory may include a magnetic storage device such as disc 436. In some embodiments, the external memories may be included in a system.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus, references to “a”, “an”, “first”, “second” etc. do not preclude a plurality. Reference signs in the claims are provided merely as a clarifying example shall not be construed as limiting the scope of the claims in any way.

1. An apparatus for capturing audio, the apparatus comprising:
a receiver arranged to receive a first set of audio signals;
an adaptive spatial decorrelator arranged to apply spatial decorrelation filtering to the first set of audio signals to generate a second set of audio signals;
a first beamformer coupled to the adaptive spatial decorrelation filter and arranged to generate a first beamformed audio output signal from the second set of audio signals;
a plurality of constrained beamformers coupled to the adaptive spatial decorrelator and each arranged to generate a constrained beamformed audio output signal from the second set of audio signals, each constrained beamformer having constrained beamform parameters and the constrained beamform parameters of the plurality of constrained beamformers forming a set of constrained beamform parameters;
an output processor arranged to generate an output audio signal from the constrained beamformed audio output signals;
a first adapter arranged to adapt beamform parameters of the first beamformer;
a difference processor arranged to determine a difference measure for each of the plurality of constrained beamformers, the difference measure for the each of the plurality of constrained beamformers being indicative of a difference between a beam formed by the first beamformer and a beam formed by the each of the plurality of constrained beamformers;
a second adapter arranged to adapt constrained beamform parameters of the set of constrained beamform parameters for the plurality of constrained beamformers with a constraint that constrained beamform parameters of the set of constrained beamform parameters are adapted only for constrained beamformers of the plurality of constrained beamformers for which a difference measure has been determined that meets a similarity criterion; and
a third adapter arranged to adapt coefficients of the spatial decorrelation filtering in response to update values determined from the first set of audio signals, the update values being determined to reduce correlation of the second set of audio signals.

2. The apparatus of claim 1 wherein the third adapter is arranged to designate at least a first constrained beamformed audio output signal of a first constrained beamformer of the plurality of constrained beamformers as a speech audio signal or as a noise audio signal; and the third adapter is arranged to update coefficients of the spatial decorrelation filtering in response to a difference measure for the first constrained beamformer if the first constrained beamformed audio output signal is designated as a noise audio signal.

3. The apparatus of claim 2 wherein the output processor is arranged to generate the output audio signal to not include a contribution from the first constrained beamformed audio output signal if the first constrained beamformed audio output signal is designated as a noise audio signal.

4. The apparatus of claim 2 wherein the third adapter is arranged to initialize a given constrained beamformer of the plurality of constrained beamformers with beamform parameters matching beamform parameters of the first beamformer in response to a detection that no beamformer of the plurality of constrained beamformers has a difference measure meeting a similarity criterion.

5. The apparatus of claim 4 wherein initializing a given constrained beamformer comprises initially designating a given constrained beamformed audio output signal of the given constrained beamformer as a speech audio signal.

6. The apparatus of claim 5 wherein the third adapter is arranged to apply a speech detection to the given constrained beamformed audio output signal and to re-designate the given constrained beamformed audio output signal from a speech audio signal to a noise audio signal in response to a detection that the given constrained beamformed audio output signal does not comprise a speech signal component having a level above a threshold.

7. The apparatus of claim 1 wherein the third adapter is arranged to initialize the given constrained beamformer only if a level of the first beamformed audio output signal exceeds a level of the constrained beamformed audio output signal from all constrained beamformers.

8. The apparatus of claim 1 wherein the second adapter is arranged to only adapt the constrained beamform parameters of the set of constrained beamform parameters for a given constrained beamformer if a criterion is met comprising at least one requirement selected from the group of:
a requirement that a level of a constrained beamformed audio output signal of the given constrained beamformer is higher than for any other constrained beamformer;
a requirement that a level of a constrained beamformed audio output signal of the given constrained beamformer exceeds a given threshold;
a requirement that a level of a point audio source in the constrained beamformed audio output signal of the given constrained beamformer is higher than for any point audio source in any other constrained beamformed audio output signal; and
a requirement that a signal to noise ratio for the constrained beamformed audio output signal of the given constrained beamformer exceeds a threshold.

9. The apparatus of claim 2 wherein a maximum number of constrained beamformers being simultaneously updated is one.

10. The audio apparatus of claim 1 wherein the adaptive spatial decorrelator is arranged to link each audio signal of the second set of audio signals with one audio signal of the first set of audio signals, and to generate the second set of audio signals, by performing the steps of:
segmenting the first set of audio signals into time segments, and for at least some time segments performing the steps of:
generating a frequency bin representation of the first set of audio signals, each frequency bin of the frequency bin representation of the first set of audio signals comprising a frequency bin value for each of the audio signals of the first set of audio signals;
generating a frequency bin representation of the second set of audio signals, each frequency bin of the frequency bin representation of the second set of audio signals comprising a frequency bin value for each of the second set of audio signals, the frequency bin value for a given audio signal of the second set of output audio signals for a given frequency bin being generated as a weighted combination of frequency bin values of the first set of audio signals for the given frequency bin;
updating a first weight for a contribution to a first frequency bin value of a first frequency bin for a first output signal linked with a first input audio signal from a second frequency bin value of the first frequency bin for a second input audio signal linked to a second output signal in response to a correlation measure between a first previous frequency bin value of the first output signal for the first frequency bin and a second previous frequency bin value of the second output signal for the first frequency bin; and the third adapter is arranged to update weights of the weighted combination including updating a first weight for a contribution to a first frequency bin value of a first frequency bin for a first output audio signal of the second set of audio signals linked with a first audio signal of the first set of audio signals from a second frequency bin value of the first frequency bin for a second audio signal of the first set of audio signals being linked to a second output audio signal of the second set of audio signals in response to a correlation measure between a first previous frequency bin value of the first output audio signal for the first frequency bin and a second previous frequency bin value of the second output audio signal for the first frequency bin.

11. The audio apparatus of claim 10 wherein the third adapter is arranged to update the first weight in response to a product of a first value and a second value, the first value being one of the first previous frequency bin value and the second previous frequency bin value and the second value being a complex conjugate of the other of the first previous frequency bin value and the second previous frequency bin value.

12. The apparatus of claim 10 wherein the third adapter is arranged to determine output bin values for the given frequency bin ω from:
y(ω)=W(ω)x(ω)
where y(ω) is a vector comprising the frequency bin values for the output audio signals for the given frequency bin ω; x(ω) is a vector comprising the frequency bin values for the input audio signals for the given frequency bin ω; and W(ω) is a matrix having rows comprising weights of a weighted combination for the output audio signals.

13. The apparatus of claim 12 wherein the third adapter is arranged to adapt weights wᵢⱼ of the matrix W(ω) according to:
$${w}_{ij} ( k + 1 , ω ) = {w}_{ij} ( k , ω ) - η ( k , ω ) [ {y}_{i} ( k , ω ) {y}_{j}^{*} ( k , ω ) ]$$
where i is a row index of the matrix W(ω), j is a column index of the matrix W(ω), k is a time segment index, ω represents the frequency bin, and η(k, ω) is a scaling parameter for adapting an adaptation speed.

14. A method of capturing audio, the method comprising:
receiving a first set of audio signals;
applying a spatial decorrelation filtering to the first set of audio signals to generate a second set of audio signals;
a first beamformer generating a first beamformed audio output signal from the second set of audio signals;
a plurality of constrained beamformers each generating a constrained beamformed audio output signal from the second set of audio signals, each constrained beamformer having constrained beamform parameters and the constrained beamform parameters of the plurality of constrained beamformers forming a set of constrained beamform parameters;
generating an output audio signal from the constrained beamformed audio output signals;
adapting beamform parameters of the first beamformer;
determining a difference measure for each of the plurality of constrained beamformers, the difference measure being indicative of a difference between a beam formed by the first beamformer and a beam formed by the each of the plurality of constrained beamformers;
adapting constrained beamform parameters of the sets of constrained beamform parameters for the plurality of constrained beamformers with a constraint that constrained beamform parameters of the sets of constrained beamform parameters are adapted only for constrained beamformers of the plurality of constrained beamformers for which a difference measure has been determined that meets a similarity criterion; and
adapting coefficients of the spatial decorrelation filtering in response to update values determined from the first set of audio signals, the update values being determined to reduce correlation of the second set of audio signals.

15. A computer program product comprising computer program code means adapted to perform all the steps of claim 14 when said program is run on a computer.
